(19) United States
(12) Patent Application Publication
(10) Pub. No.: US 2006/0181537 A1
(43) Pub. Date: Aug. 17, 2006

(54) Cybernetic 3D music visualizer

(76) Inventors: Srini Vasan, Van Nuys, CA (US); Rik Henderson, Chatsworth, CA (US); Vladimir Bulatov, Corvalis, OR (US)

Correspondence Address: 3D MAXMEDIA INC;SUITE 101, 6911, HAYVENHURST AVENUE, VAN NUYS, CA, 91406, US

(21) Appl. No.: 11/339,740

(22) Filed: Jan. 25, 2006

Related U.S. Application Data
(60) Provisional application No. 60/646,427, filed on Jan. 25, 2005.

(51) Int. Cl. G06T 15/70

(52) U.S. Cl. 345/473

(57) ABSTRACT

3D music visualization process employing a novel method of real-time reconfigurable control of 3D geometry and texture, employing blended control combinations of software oscillators, computer keyboard and mouse, audio spectrum, control recordings and MIDI protocol. The method includes a programmable visual attack, decay, sustain and release (V-ADSR) transfer function applicable to all degrees of freedom of 3D output parameters, enhancing even binary control inputs with continuous and aesthetic spatio-temporal symmetries of behavior. A “Scene Nodes Graph” for authoring content acts as a hierarchical, object-oriented graphical interpreter for defining 3D models and their textures, as well as flexibly defining how the control source blend(s) are connected or “Routed” to those objects. An “Auto-Builder” simplifies Scene construction by auto-inserting and auto-routing Scene Objects. The Scene Nodes Graph also includes means for real-time modification of the control scheme structure itself, and supports direct real-time keyboard/mouse adjustment to all parameters of all input control sources and all output objects. Dynamic control schemes are also supported such as control sources modifying the Routing and parameters of other control sources. Auto-scene-creator feature allows automatic scene creation by exploiting the maximum threshold of visualizer set of variables to create a nearly infinite set of scenes. A Realtime-Network-Updater feature allows multiple local and/or remote users to simultaneously co-create scenes in real-time and effect the changes in a networked community environment where in universal variables are interactively updated in real-time thus enabling scene co-creation in a global environment. In terms of the human subjective perception, the method creates, enhances and amplifies multiple forms of both passive and interactive synesthesia. The method utilizes transfer functions providing multiple forms of applied symmetry in the control feedback process yielding an increased level of perceived visual harmony and beauty. The method enables a substantially increased number of both passive and human-interactive interpenetrating control/feedback processes that may be simultaneously employed within the same audio-visual perceptual space, while maintaining distinct recognition of each, and reducing the threshold of human ergonomic effort required to distinguish them even when so coexistent. Taken together, these novel features of the invention can be employed (by means of considered Scene content construction) to realize an increased density of “orthogonal features” in cybernetic multimedia content. This furthermore increases the maximum number of human players who can simultaneously participate in shared interactive music visualization content while each still retaining relatively clear perception of their own control/feedback parameters.

### REFERENCES

(1) U.S. Pat. No. 6,395,969 May 28, 2002 Fuher, John Valentin “System and method for artistically integrating music and visual effects”

(2) US Patent Application #20050188012 Aug. 25, 2005 Dideriksen, Tedd “Methods and Systems for synchronizing visualizations with audio streams”

### FIELD OF THE INVENTION

The present invention relates to a real-time 3D music visualization engine for creating, storing, organizing, and displaying a vast scope of music-synchronized 3D visual effects in a true interactive 3D space for use in production of pre-recorded multimedia content as well as for live interactive multimedia performances.

### BACKGROUND OF THE INVENTION

For some decades a variety visual media production methods have been employed to enhance the enjoyment and increase the perceptual impact of musical content. These have ranged from simple sequences of time synchronized still images, to precisely timely lighting systems, to carefully composed video content that in general changes in perceivable time to the rhythm and beat of the musical track or performance.

More recently computer graphics have been employed in this endeavor in a variety of applications. These include use for public performances including for live music performance by a new class of strictly visual performer known as a Visual Jockey or simply “VJ” artist; by the now widely deployed home computer users with their digital MP3 music player “visualizers,” as well as for more sophisticated music video and feature film productions. When employed in a real-time context it has nonetheless become popular to “mix and match” the audio and visual elements to be synchronized, that is, to support the user's selection any arbitrary pre-recorded musical track and an arbitrary selection from a library of visualizer “pre-sets” thus customizing the users resulting multimedia experience with a unique result, or at least one apparently so out of a very large set of possible combinations.

These previous methods however, are all relatively limited in scope of aesthetic possibilities, and especially when employed in real-time, are limited to their music-synchronized effects being employed either in flat 2D or in a “pseudo-3D” or “2 1/2-D” environment. The latter is evidenced by the many visualizers, which for example by such as clever use of real-time lissajous and/or particle engine type of effects give a basic subjective impression of a 3D result. This perception is however but an illusion and is limited, as in reality these visualizer methods are not functioning in a true 3D environment at all. This lack may be quickly confirmed by the inability to arbitrarily and in real-time move camera position and viewpoint as is the case in a true 3D scene, as well as the inability to import arbitrary external 3D models into the scene and animate their parameters to music and player actions in real-time while retaining their full 3D characteristics, and the lack of such 3D capability as to choose amongst alternative texture maps and variously apply those to the 3D models in real-time.

The use of MIDI (Musical Instrument Digital Interface) has also become common in the available Music Visualizer software systems. However, compared with the potential richness of the MIDI message protocols, variety of message types and dynamic range, the available range of triggered results is relatively primitive and the protocol is not deeply exploited. MIDI triggers are typically limited either to responses such as calling up a particular 2D image or 2D video stream associated with a particular MIDI Note message, or applying 2D video effects upon 2D content by MIDI Continuous Controller messages. Applying MIDI triggers directly to 3D visual effects in real-time has either been severely limited in scope and flexibility due to limited system design, or when attempted is otherwise plagued by severe rendering latency issues which degrades the perceived synchronicity and thus also degrades the aesthetic result.

Visualizers which lack MIDI trigger as an option are even more severely hampered, as the alternatives of ASCII computer keyboard for example are limited by lack of velocity (i.e. are strictly binary) and typically limited to a maximum “polyphony” of two to four simultaneous triggers (keys) only. For extended or complex media play the physical configurations of ASCII keyboards are also ergonomically undesirable and fatiguing. The computer ASCII keyboard and the QWERTYOP typewriter-style key arrangement are designed primarily for left-and-right alternating, one-at-a-time key presses, as contrasted to the demands of complex performance where multiple simultaneous triggers are required including with one or the other hand alone at a given time. While some visualizers do support MIDI input devices, their trigger-to-response feature set is so limited they do not exploit the potential for MIDI devices to overcome the limitations of ASCII keyboards.

Furthermore, the application of synchronization techniques between audio spectrum and/or MIDI live triggers to the visualizers' animation parameters have to date been lacking any functional equivalent to the technique widely used in audio synthesizers known as ADSR or Attack, Decay, Sustain and Release, whereby a relatively simply initial trigger, even a binary trigger, can be smoothed into a more aesthetic shape of response over time. This has left much of music visualizer content with a jerky, primitive feel, as compared to the aesthetic finesse of finely crafted music synthesizer and digital audio musical events which can emulate the analog temporal characteristics of acoustic music instrument responses.

Furthermore, the previous visualizers' severe limits on scope of available simultaneous types of synchronization and extremely limited choices of visual parameters modulation have precluded the ability of multiple players and/or combinations of live players and audio to simultaneously co-exist in the multimedia result at all, or, when available to evidence a result of “visual cacophony” or confusion where distinct synchronization between each separate player, and/or between player(s) actions and audio modulation are not distinct feedback loops but a merged collective result.

Users who participate actively in a club/concert environment need to experience the real-time 3D without any delay in the rendering process. In addition, the graphical display must interact with the music, with the user inputs and user responses in real-time at the same time. These two prime requirements have been lacking in the field to date.

The Cybernetic 3D Music Visualizer invention with its sliders and keyboard sensors, accessible parameter detail windows, “auto magic mu” and oscillators allow any end-user to make changes to visualizer scenes in real-time without any programming effort. In addition, all the 700 or more variables are accessible to the user in real-time and any and all changes are reflected in real-time.

Any acoustic musical instrument can be considered in terms of a feedback system. In that case, not only the resulting output sound, but also tactile parameters such as backpressure, resonance, muscle tension, reed vibration or string tension provide the player with additional feedback features which assists in their ability to tightly control the desired output results. In general in cybernetics, for any control feedback system to be effective, the operator must be able to receive adequate feedback, in a way not confused with other feedback parameters or other operators' control-feedback loops. This invention provides an expansion of simultaneous coexisting control-feedback loops to a very high dimensionality feature space, such as (n) color features+(n) shape features+(n) particle features+(n) lighting features, etc. This provides to the field of 3D visual music performance a complexity and subtlety of creative expression that is two orders of magnitude greater than previous methods; (i.e. on the order of 800 independent visual parameters in the invention, vs. typically less than ten such parameters in previous visualizers).

In addition, the current generation of music visualizers which are less intelligent, stand-alone and non-3D or only pseudo-3D-lookalikes, do not provide the capabilities of letting multiple users to simultaneously “jam” and co-create 3D architected scenes in real-time. This severely limits the creativity of a group environment wherein the best of the best creative inputs are provided in real-time and a consensus based universal scenes could be orchestrated.

Our invention of the Real-time-Network-Updater feature allows multiple users to simultaneously co-create visualizer scenes in real-time and effect the changes in a networked community environment where in visualizer variables are interactively updated in real-time thus enabling visualizer scene co-creation in a global environment. This capability of utilizing the same set of variables in a multi-user environment supports variable types and values available both globally (networked) and locally.

In addition, the current generation of visualizers have limitations because of the inefficiency of the manual manipulation of parameters through a large number of permutations and combinations a user is going to experiment with to create a set of new objects/scenes. Thus there is a requirement of an intelligent automatic parameter increment technology which takes care of automatically incrementing through the combinations of variables, to breakthrough the limits of manual trial-and-error, and auto-create limitless possibilities of scenes.

In the pre-recorded case, (or simply enjoying a scene passively without interactive consideration), as well as in the interactive case, the invention provides what is subjectively reported as a “more beautiful” or “more satisfying” multimedia experience. We believe this is for the reasons that the invention's methods of synchronization between music and visual effects are occurring in a manifold of transfer functions, and that most of these transfer functions employ symmetry. Music can directly and simultaneously modulate the 3D visual field in a greater number of ways, in a greater variety of ways, and in more aesthetic ways when employing our invention.

In the live interactive performance application, the invention furthermore extends the field of music visualization to the cybernetic level of system. The invention provides means to easily control a vast scope of distinct and simultaneous 3D visual modulation parameters, through a high dimensionality feature space currently comprised of hundreds of independent parameters. This richness of output feature space makes human ergonomic control of simultaneous multiply combined visual effects both viable and clear. Easy perception of multiple distinct cybernetic control-feedback loops can be provided even in the context of such densely superposed effects. The multiple feedback media results (output visual features) linked to input controls may easily be selected to be sufficiently orthogonal from amongst the total scope of available parameters. For these same reasons the invention empowers multiple live “visual music players” to both unambiguously and expressively co-create in real-time in a shared 3D music-visual art form including to that of substantially virtuoso levels.

### SUMMARY OF THE INVENTION

1. Scenes. A 3D Visualizer ‘Scene’ is the data store which defines what resources including 3D geometries (models) are present, what textures are available, what effects are applied, and what scope and mix of input control sources are used to affect those resources at visualization runtime in the multimedia output. Each Scene completely defines the matrix of transfer functions of how those control sources, when applied as inputs, subsequently affect the 3D resources.
2. Nodes Graph Scene Interpreter. The 3D music visualization process employs a Scenes ‘Nodes Graph’ which acts as a hierarchical graphic and object-oriented interpreter for manipulating 3D models, textures and effects. The Nodes Graph is a convenient graphic user interface (GUI) approach. It organizes a Scene author's access to a number of object parameter configuration dialog windows, which when all are configured as desired, constitutes a functional Scene.
3. Parameter field (GUI) control. The Scene Interpreter GUI in its parameter dialog windows also supports direct real-time keyboard/mouse adjustment to alphanumeric parameter fields, with immediate results apparent in the relevant runtime multimedia outputs. This direct alphanumeric field data entry with immediate media output is useful to scene authors for testing output results and for making informed input-control-output design decisions for Scene construction. An optional Auto-Cycle-Parameters function also expedites searching through the vast combinations of parameter settings for a given object to locate aesthetic defaults and limits.
4. Control Blends. The 3D Visualizer employs a novel method of real-time configurable control of 3D geometry, texture and effects employing one or more ‘control blend’ combinations of software oscillators, computer keyboard and mouse, audio spectrum, MIDI protocol, and Control Recordings.
5. Flexible Control Routing. The Scene Nodes Graph flexibly defines how input control sources are connected or “Routed” to control those output objects' geometries, textures and effects. The Scene Nodes Graph also includes means for real-time modification of the control scheme structure itself. Dynamic control schemes are also supported, including real-time modification of Routing, such as control sources modifying the Routing and parameters of other control sources. The Routing implementation supports one-to-many, one-to-one, many-to-many, and many-to-one control topologies.
6. MIDI Implementation Details. MIDI is the 3D Visualizer's interactive control means of choice, having the most substantial range of power, flexibility, nuance of expression, and multi-player capabilities. MIDI is a vastly greater control space compared to PC keyboards; MIDI's thousands of messages including (n)=128+polyphony, velocity and continuous controller variations vastly exceeds a mere hundred or so PC keystrokes and having most (2)- or (3)-polyphonic, binary switches. The MIDI control protocol is sufficiently exploited to fully support the total flexibility and scope of the 3D Visualizers control and effects
7. Visual-ADSR. The method includes a configurable Visual Attack, Decay, Sustain and Release (‘V-ADSR’) transfer function applicable to any degree of freedom (feature vector) of 3D output parameters, enhancing even binary control inputs with continuous and aesthetic spatiotemporal symmetries of behavior.
8. Symmetric Transfer Functions and Perceived Beauty. The method utilizes transfer functions providing multiple forms of applied symmetry in both passive (non-human-controlled) outputs as well as the human-controlled feedback processes. The multiple applications of symmetry increase the level of perceived visual harmony and beauty. Symmetry also enhances pattern recognition in control/feedback.
9. Synesthesia. In terms of the human subjective perception, the method enables multiple forms of both passive and interactive synesthesia which may be variously combined, layered and implemented separately or simultaneously.
   (Note: for convenience, the above Summary of the Invention's nine numbered paragraphs above corresponds in topic number to the nine major numbered sections in the Detailed Description of the Invention disclosed below.)

### BRIEF DESCRIPTION OF THE FIGURES

FIG. 1 illustrates an Overview of Scenes and 3D Visualizer Functional Architecture.

FIG. 2 illustrates the Initial Nodes Graph Structure for Starting to Author a New Scene.

FIG. 3 illustrates the Minimal Required Objects to Add to a Default (New Scene) Nodes Graph.

FIG. 4 illustrates the Recommended Minimal Objects for a New Scene (Conceptual).

FIG. 5 illustrates the Nodes Graph for a Simple, 1-Route Case.

FIG. 6 illustrates Selecting a Route's ‘To’ Object.

FIG. 7 illustrates Selecting a Route's ‘To’ Object Parameter

FIG. 8 illustrates the Six Additional (Optional) Object Types.

FIG. 9 illustrates the Edit/New Menu for Inserting Objects into a Nodes Graph.

FIG. 10a is a Table the Visualizer Objects and Number of Animatable Parameters for Each Type.

FIG. 10b (Continues the Objects Table from 10a).

FIG. 10c (Continues the Objects Table from 10b).

FIG. 10d (Continues the Objects Table from 10c).

FIG. 10e (Continues the Objects Table from 10d).

FIG. 11 illustrates several example Object Properties Dialog Windows.

FIG. 12 illustrates the Blending Control Sources, shown for a One-to-Many Transfer Function.

FIG. 13 illustrates the Control Blend in more Detail.

FIG. 14 illustrates an Example First Control Blend Output.

FIG. 15 illustrates an Example Second Control Blend Output.

FIG. 16 illustrates an Example allocation of Animators over MIDI Piano keys.

FIG. 17 illustrates the Example allocation of Animators over PC ASCII Keys and MIDI Notes Table (corresponding to FIG. 16.)

FIG. 18 illustrates an Example allocation of MIDI Switch Animators over MIDI Piano keys.

FIG. 19 illustrates the Example allocation of MIDI Switch Animators over MIDI Notes Table (corresponding to FIG. 18.)

FIG. 20 illustrates an Allocated Control Example 1; a Many-to-Many Case.

FIG. 21 illustrates an Allocated Control Example 2; a Many-to-One Case.

FIG. 22 illustrates an Allocated Control Example 3; another Many-to-Many Case.

FIG. 23 illustrates an Allocated Control Example 4: a Variation of Many-to-One Control.

FIG. 24 illustrates an Allocated Control: A One-to-Many (Features) Example.

FIG. 25 illustrates an Allocated Control: A One-to-One Example.

FIG. 26 illustrates an Allocated Control: A One-to-Many (Models) Example.

FIG. 27 illustrates the Supported MIDI Messages.

FIG. 28 illustrates the Animator MIDI Tab's Checkboxes.

FIG. 29 is a table of MIDI Animator Control Styles.

FIG. 30 is a table of MIDI Note On Control Styles.

FIG. 31 is a table of MIDI Polyphonic Aftertouch Control Styles.

FIG. 32 is a table of MIDI Control Change Control Styles.

FIG. 33 is a table of MIDI Pitch Bend Control Styles.

FIG. 34 illustrates the AnimatorParameter MIDI Tab fields, noting V-ADSR parameters.

FIG. 35 illustrates the V-ADSR Conceptual Envelope.

FIG. 36 illustrates the Auto-Cycle pane controls available in any object Parameter (detail) window.

### DETAILED DESCRIPTION OF THE INVENTION

1. Scenes

Overview of Scene Function

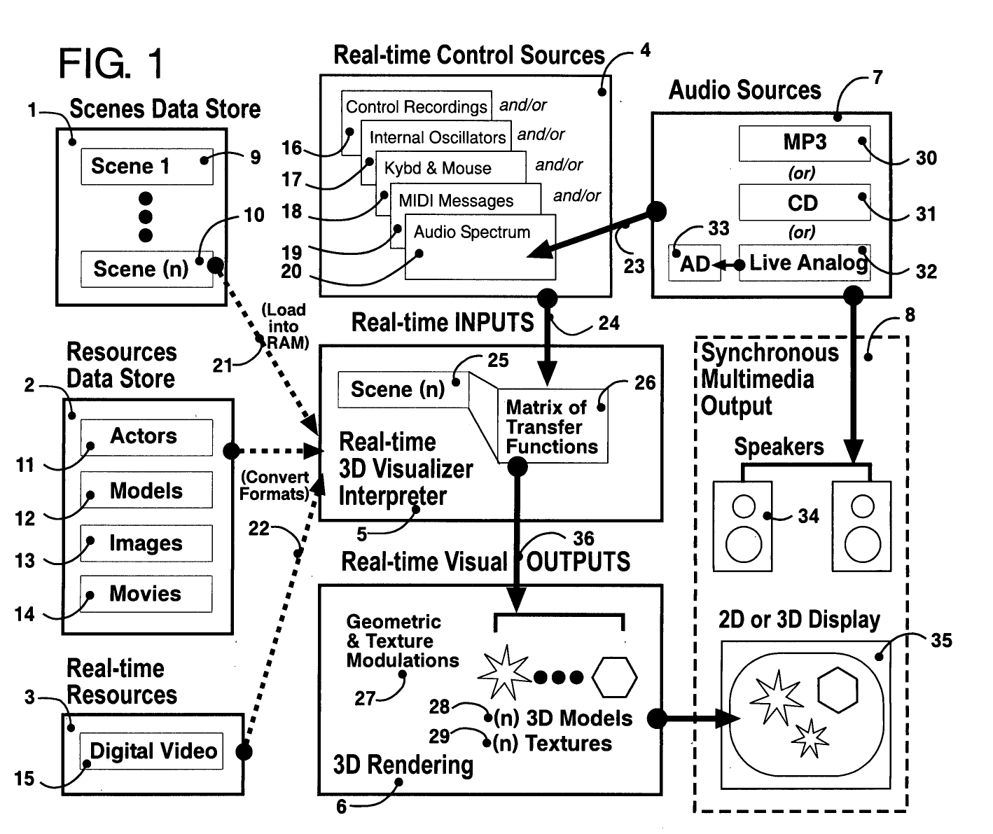

Referring in particular to FIG. 1, when a particular scene [1] is loaded into RAM memory [21], the visualizer also loads whatever resource files [2] are required by that particular scene. Resources may include: 3D models [12] (platonic solids, polyhedra, etc.); 3D actors [11] (more complex models, including 3D animations); images [13] (usually JPEG format images); movies [14] (usually AVI format digital movies); and live digital video [15] (usually DV over IEEE-1394) feed. The real-time 3D Visualizer Interpreter [5] at initial load time converts [22] the various external media resources [2,3] from their native data formats into an internal, algorithmic set of 3D data structures [25] suitable for complex real-time 3D manipulation and rendering [6]. Then the interpreter [5] applies whatever scene-defined inputs of real-time control sources [4] including whatever audio source [7], all according to the matrix of transfer functions [26] defined by the scene [25], to perform various geometric and texture manipulations [27] upon the affected parameters of those resources [2,3]. The 3D data structures are continuously rendered [6] and output to a 2D or 3D (stereoscopic) display device [35]. At the same time, whatever audio source [7] was used as an input control source into the visualizer is also sent in parallel, as audio via typical audio amplifier and speakers [34] into a combined audio-visual multimedia space [8]. The real-time 3D visualizations are performed at such a high speed that the results in audio-modulated visuals and audio are perceived as simultaneously occurring in [8].

Reduction to Practice

A scene data store [25] resides in volatile memory (RAM) at visualization run-time, or in non-volatile memory (hard disk file) for offline storage [1] and recall. As currently reduced to practice in software, a duly-constructed scene is loaded into volatile memory for the 3D visualizer interpreter [5]application software to function as intended. The cybernetic processes [26] of the disclosed 3D Visualizer could alternatively be implemented in whole or in part utilizing custom hardware. The invention as a cybernetic multimedia control/feedback system is thus deemed equivalent whether it is reduced to practice by using either software or custom hardware means.

Player Mode

The visualizer may be operated in a purely “Player Mode,” by simply loading a previously-authored Scene file [9,10] into RAM, and (optionally) activating one or more inputs [4] (keyboard/mouse [18], audio source [20] and/or MIDI [19] devices). The scene interpreter [5] then produces a 3D visual display [36]. In this case, the user [75] enjoys the control/feedback from inputs to outputs (which may be passive and/or interactive in nature) and may do so without considering the internal scene structure [25,26] or any configuration details.

2. Nodes Graph Scene Interpreter

How a Basic Scene is Put Together

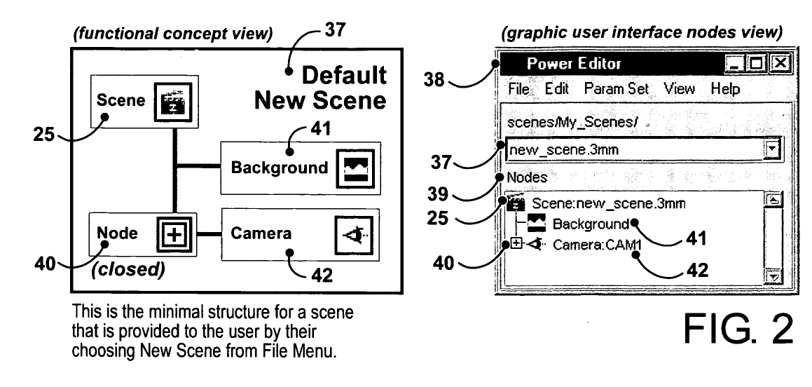

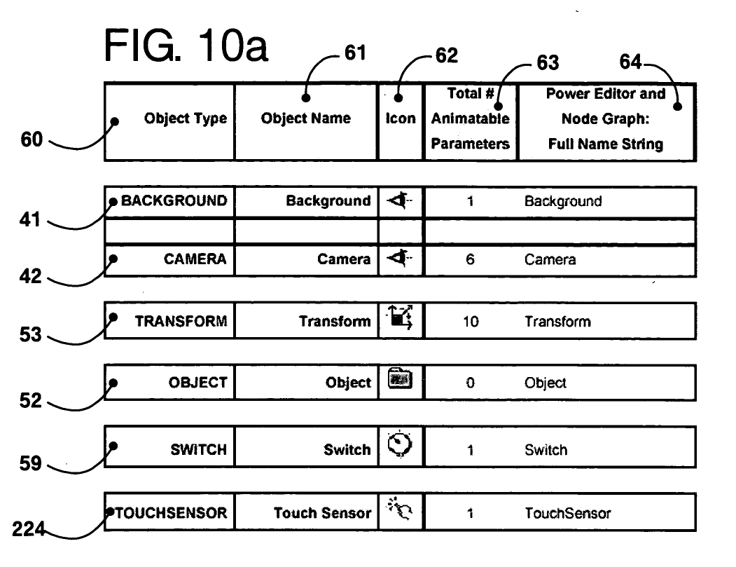

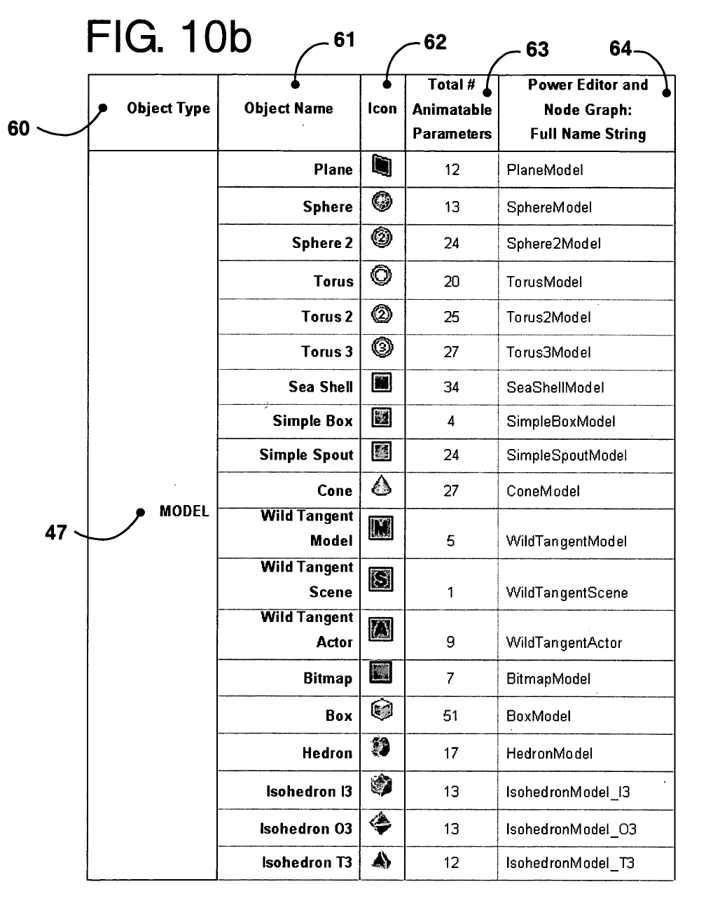

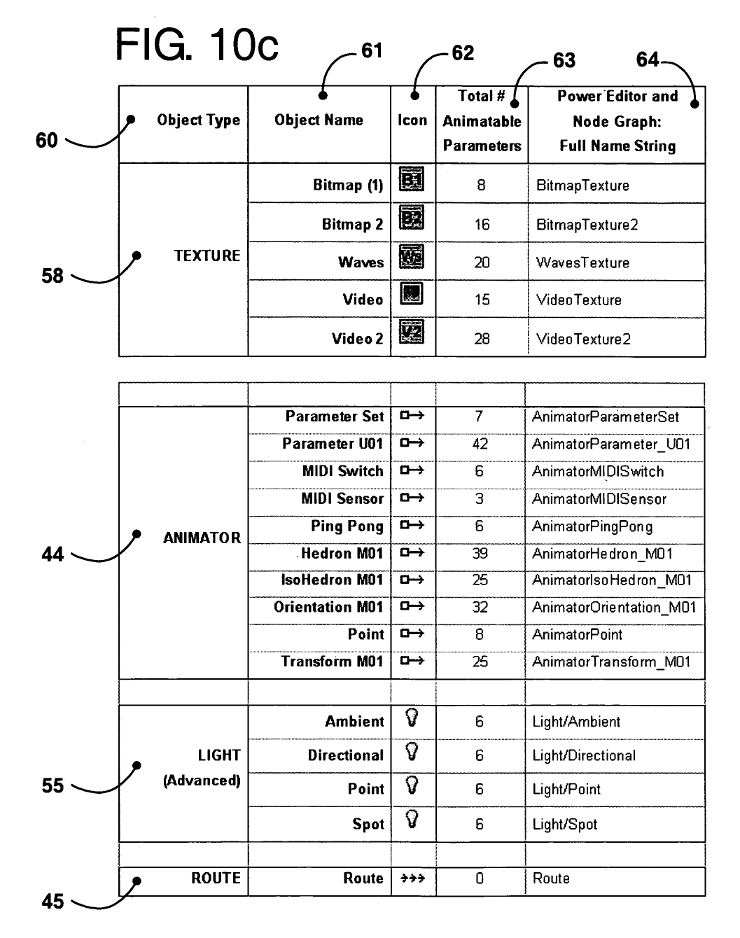

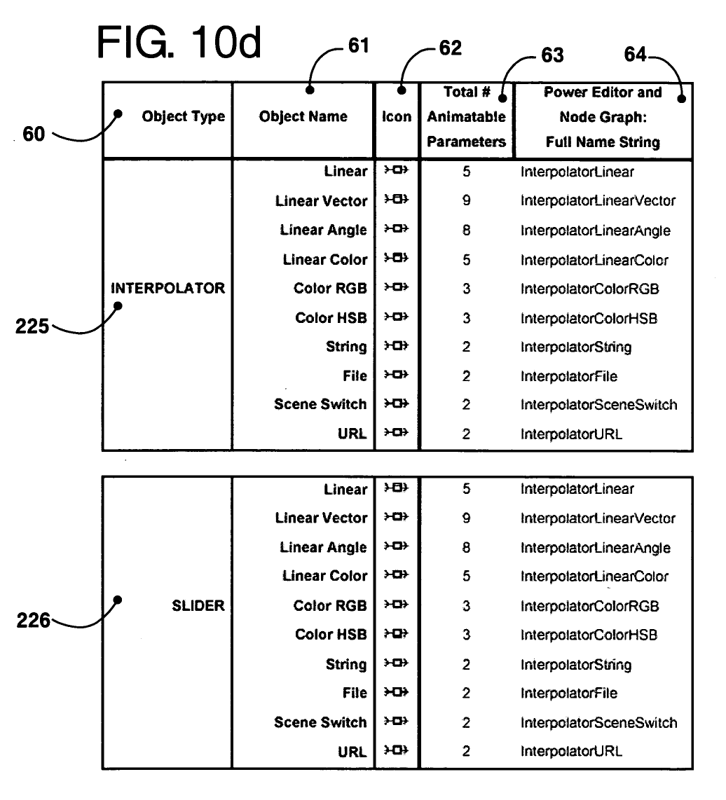

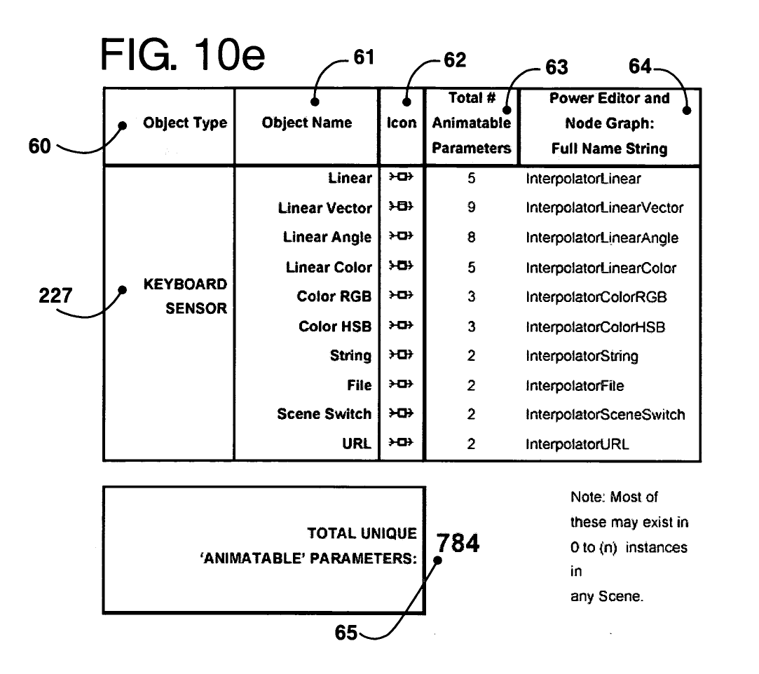

Refer to FIG. 2 (and FIGS. 10a-e). A 3D visualizer scene [25] is constructed of various Objects [61] that are symbolized in graphical format in the nodes graph [39] pane in a Power Editor window [38] when scene authoring (which can be in full visualization runtime).

New Scene's Default Camera Node

First we'll look at how a “basic” (absolute minimal functional) scene is built up. When a New Scene [37] is selected from the Power Editor [38] file menu, the nodes graph pane [39] displays a starting minimal Camera [42] and Background [41]. Also, hidden beneath the closed node [40] is also a basic Light [55] These basic objects and this basic scene structure will get a scene author started [37]. While certainly it's possible to vary and even animate the Camera [66] and Light objects considerably in more advanced situations, in the simplest case the author can accept the default.

Required Minimal Objects to Add

There are at least three minimal Objects [43] a 3D Visualizer Scene must include, to achieve any type of animation: an Animator [44], a Route [45], and a Model [47]. Without at least these three objects, a visualizer scene won't do anything (such as respond to music.) It's a simple idea to add, to the New Scene default Node Graph, a Model (like a Torus [47] with an Animator [44] to animate it. Very important to also clearly illustrate is how the Route object works. A Route [45] is how one connects an Animator [44] to a Model Parameter [49], or to other types of Objects [61] which we'll illustrate further below. (There are some special-case exceptions, namely Objects included in the visualizer system's repertoire that don't need Routes to be actively animated in a scene.)

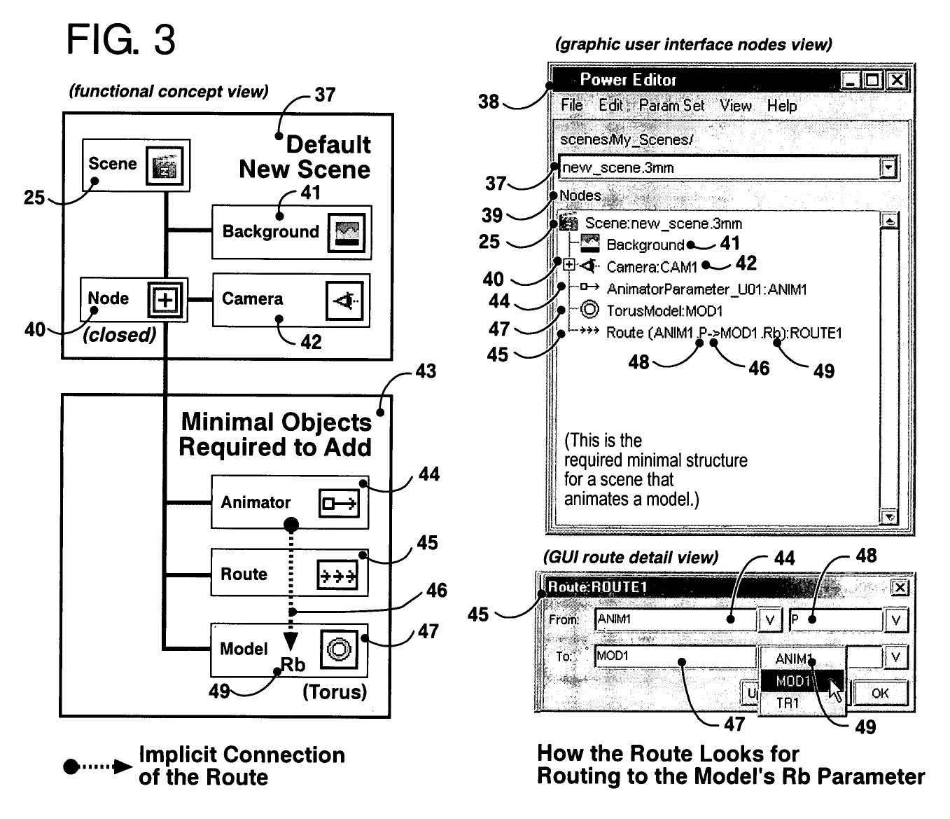

The parenthetical text in the Route [45] object line of the nodes graph [39] also shows which specific animator parameter [48] is routed or connected [46] to which specific model parameter [49], in the example shown. In a simple case example, shown in FIG. 3, the Animator Model (a Torus [47]) and the Route [45] have all been inserted under the “top,” or Scene Node [40]. A minimal scene will function correctly when the Nodes Graph is setup as shown below in FIG. 3, but it has minor disadvantages:
a. First, if later an author wishes to copy objects into another scene, they would have to carefully select all of them in the Nodes pane before copying and then pasting all of them into another scene (also very carefully). This can get somewhat user-error-prone when there are a lot of objects in the two scenes.
b. Second, when setting up the fields of the Route window [45], the pull-down lists [44, 47] show the choices for the default Camera Node [42], including the Camera, a Transform [56], and two Lights [55,57]. Since an author rarely will Route to those in most cases, this clutters the list of choices when setting up the Route [45]. This situation can really get out of hand when adding several more Models and Animators, that being a little confusing (for a beginning Scene author anyway) when Routing all those objects.

The above disadvantages (of the absolute simplest minimal case) are easily remedied, by also using an Object Folder [52], as we illustrate next.

Recommended Minimal Objects to Add to a New Scene

Thus it is recommend the scene author setup even such a basic scene like we show here, by first adding a New Object Folder [52], and then under that insert at least one new Transform [53]. The scene author should insert at least one Transform [53], but can opt to alternatively insert several nested Transforms (especially if independent 3-axis spatial position and/or orientation modulations are anticipated). Only next add the new Animator [44], Model [47] and Route [45] (also under the Object folder [52], by highlighting it before choosing New . . . from the Power Editor's [38] Edit Menu).

Even before configuring the Route [45], since there is just one Model [47] and one Animator [44] under the Object folder [52], it is implied that the Route [45] is going to connect those two things, as we illustrate above. But nothing will actually happen (or animate in the scene) until the Route is configured. The connecting link the Route provides [46] is not drawn graphically in the Nodes [39] pane; however one can easily see what it does in the text description of the Route [45], which in this case clearly displays (ANIM1.P->MOD1.Rb)

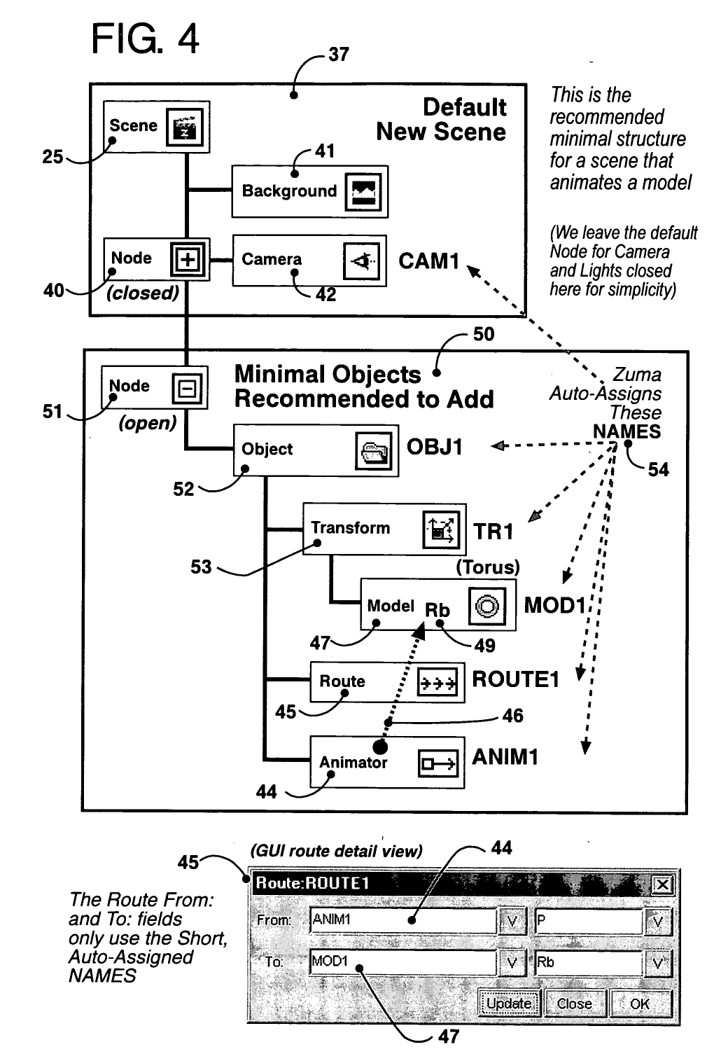

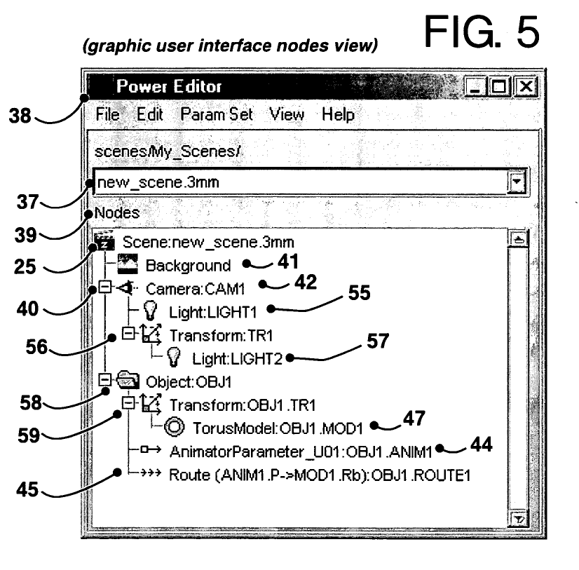

Referring to FIG. 5, we see how the conceptual FIG. 4 relates to the actual Scene Nodes [39]. In this example view all nodes [40,56,58,59] are expanded.

Setting up Routes

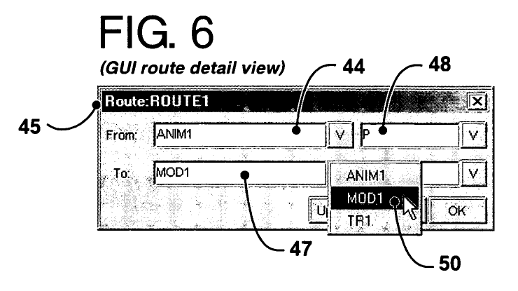

We here consider Routes in regards to their scene authoring setup and display at the high-level GUI view of the Power Editor [38] Nodes Graph [39] and in the Route detail window (see FIG. 6). The flexible interconnect topologies and cybernetic implications we consider below in this patent disclosure.

In the example shown in FIG. 5, and as illustrated in FIG. 4, the 3D Visualizer as has automatically assigned some “abbreviated” object names for each object in the scene (OBJ1, TR1, MOD1, etc.). Object text strings also reflect any hierarchy of object folders included in the scene nodes graph (OBJ1.TR1, OBJ1.ROUTE1, etc.) These short names are all a scene author has to pay attention to when setting up a Route. When the Route is setup, it displays in it's pull-down lists [50,51] only the relevant objects under the shared parent Node, the Object Folder (and notably not also other objects such as exist by default under the Camera Node.) This makes choosing things in the Route dialog pull-downs simpler.

In this example, we Route [45] from the Animator [44] or ANIM1; (the AnimatorParameter_U01 always has only the “P” [48] parameter), to the Torus model [47] which is simply MOD1 in this example. Once the To object [47] is selected, the choices in it's right-hand or parameters pull-down list [49], will only be those that can be routed to for that object. This pull-down [49] is contextual, so a scene author should always choose the To object in the left-hand field [47] first, and then choose the specific parameter [50] you want the animator to control.

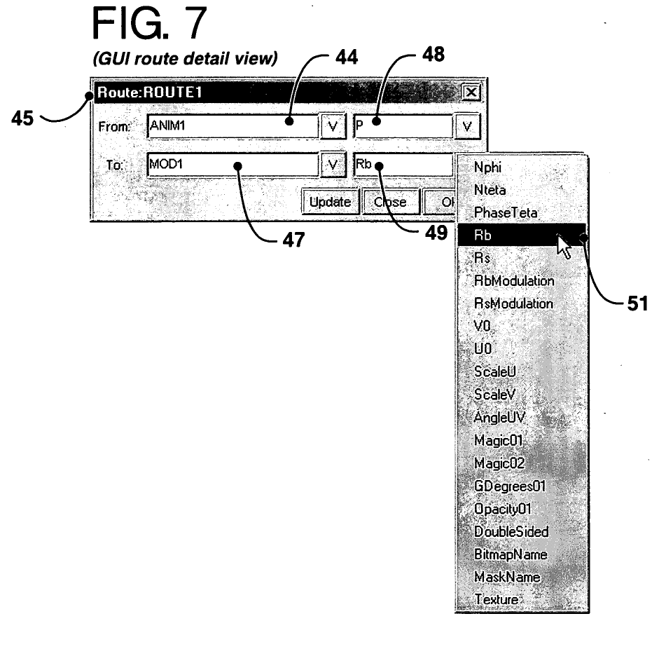

Referring to FIGS. 2, 3, 4, 5, 6, and 7 in summary: a New Scene includes by default three of the 3D Visualizer's Object Types namely Camera, Transform, and Light. A Scene author also must add at least three more Types of 3D Visualizer Objects to get the scene to do anything (animate or modulate objects and/or parameters in the visual domain), namely at least one Model, one Animator and at least one Route.

A 3D visualizer scene author can accomplish creating quite a vast repertoire of scenes using only these six types of Objects: one can build up a sophisticated 3D Visualizer scene for example using multiple Animators with multiple Routes connecting into either different parameters of a single Model, or routed to multiple Models. We show this conceptually in our further sections below.

Setting Up More Complex Scenes

Optional Objects to Add

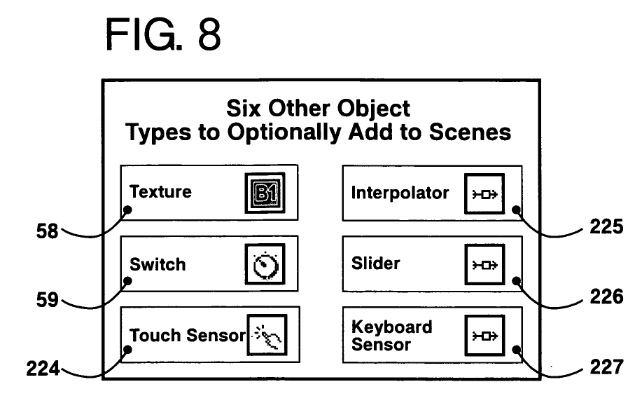

However, referring to FIG. 8, we note there are an additional six “Classes” [60] or kinds of Objects you can also use in Visualizer scenes, namely Texture [58], Switch [59], Touch Sensor [224], Interpolator [225], Slider [226], and Keyboard Sensor [227]:

The Fourteen Classes of 3D Visualizer Objects

Including the (unavoidable) Camera [42], and the (optional) Object Folder [52] which doesn't do anything itself but encapsulates other Objects, this brings the grand total number of fundamentally different 3D Visualizer scene Object Types or Families [60] to fourteen:
1. Camera [42] (always one, and always automatically inserted by the 3D Visualizer)
2. Background [41] (always one, and always automatically inserted by the 3D Visualizer)
3. Lights [55] (at least one is required)
4. Models [47] (at least one is required)
5. Animators [44] (at least one is required)
6. Routes [45] (at least one is usually required)
7. Object Folders [52] (optional)
8. Textures [58] (optional)
9. Transforms [53] (optional, other than the one always included in the default Camera node)
10. Interpolators [225] (optional)
11. Sliders [226] (optional)
12. Keyboard Sensors [227] (optional)
13. Switches [59] (optional)
14. Touch Sensors [224] (optional)

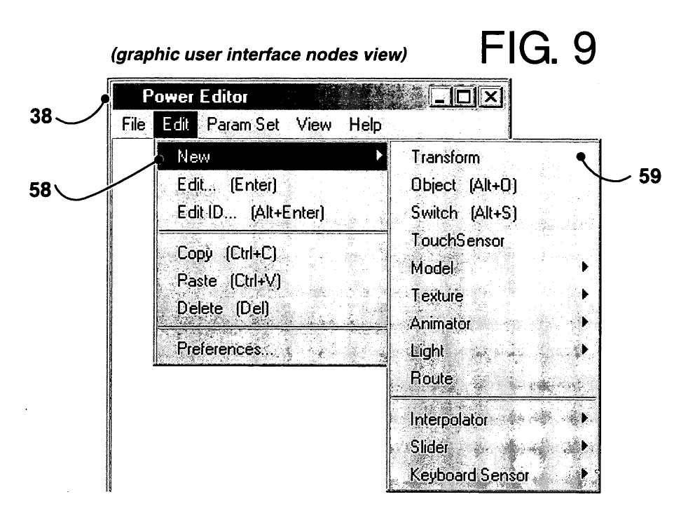

Referring to FIG. 9, we find all of these 3D Visualizer Object Types [60] and the objects beneath them in the Power Editor's [38] Edit\New sub-menu [59] (with the exception of the Camera [42] object since it is automatically inserted by the 3D Visualizer in any default New Scene). It is important to note that any of these objects may appear in one instance or in a plurality of (n) instances in any given scene.

3D Visualizer Objects

All of the object [61] variations within each Type or Family of Object [60], Nodes Graph icons [62] and also the total number of animatable parameters [63] for each object are all summarized in FIGS. 10a-10e. The tables therein list all of the same 74 Objects that are found under the Power Editor's “New . . . ” Menu [58] (including the two types of default Objects that are always there to start with, namely Camera and Background). The number of animatable parameters listed [63] for each object [61] gives at least a general idea of which types of objects have what number of parameters to potentially route up to and control.

3. Changing Object Parameters in Real-Time Using the Power Editor

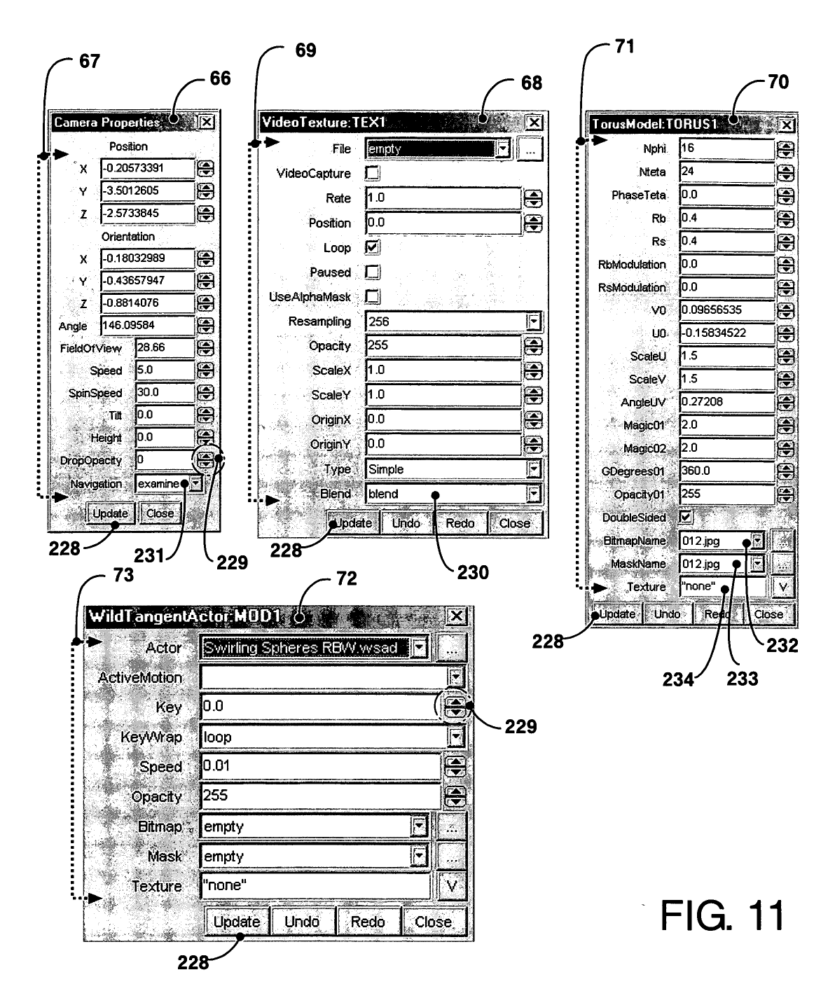

Refer now to FIG. 11, which shows four example Object Properties (detail) windows, namely those for Camera [66], Video Texture [68], Torus Model [70] and Wild Tangent Actor [72]. Also shown are their corresponding parameter fields [67,69,71,73].

Alphanumeric Field Real-Time Control of Parameters with Live Response

To change parameters for any scene object, and to instantly see the results ‘live’ in the modulated (changing) object in a scene, one can simply mouse-click and drag in the parameter field [67,69,71,73] of interest. The increment and decrement arrow buttons [229] can alternatively be used. The results of any such changes will be, in most cases, immediately apparent in the 3D Visualizer scene window—and in the rare exceptions, certainly the changes will be visible in the scene once the Update [228] button is clicked. Doing this systematically with parameters for one or more objects in an existing 3D Visualizer scene, is a quick way to discover new and often unexpected variations in the 3D art. And it's an easy way to explore the effect of changing parameter values, both while constructing a scene and at performance runtime.

It works just like this for most all parameter fields for all objects in their parameter (detail) windows [66.68.70.72]. There are two notable exceptions here. One is that some of the parameters (variables) have drop-down menus [230] instead of numeric fields. In the Camera Properties Dialog [66] the Navigation [231] parameter is an example of this. In this case one simply uses the drop-down menu to effect the desired change. Another example of this is that some objects (“Models”) have textures [234] (Bitmap [232] or BitmapName) and Masks (Mask [233] or MaskName) that can be changed by drop-down menus.

Live Auto-Cycle of Parameters to Explore Object Parameter Combinations

This technique is the quickest best way to also explore an object such as any Model for example, in order to initially discover which of its parameters will be most aesthetic to subsequently Route or “wire up” to using Animator(s).

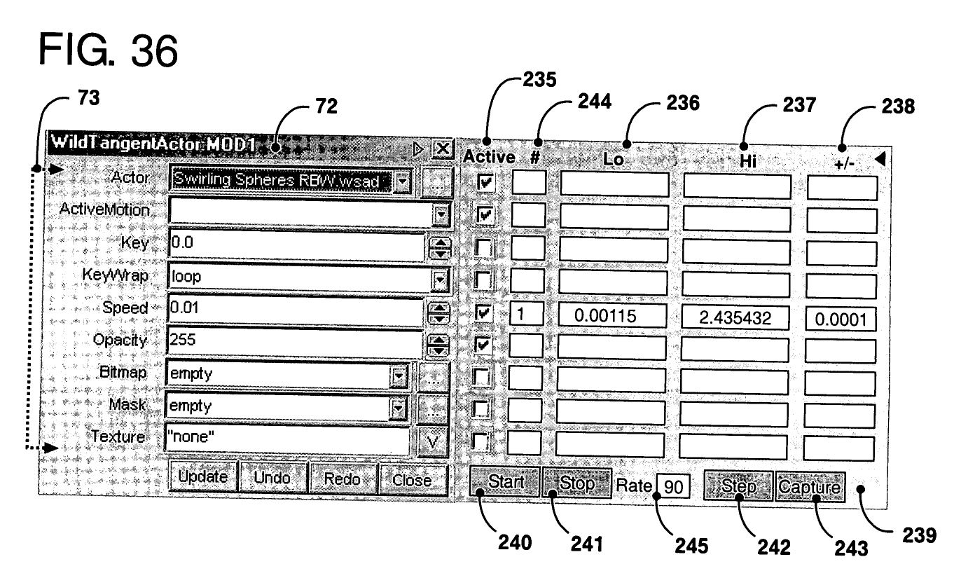

Referring to FIG. 36, the user can open an optional Auto-Cycle side-pane [239] for any object parameter window, to display an additional set of Auto-Cycle controls. These add, for each parameter field of the object, an Enable Auto-Cycle checkbox [235], a Low Value field [236], a High Value field [237], a Cycle Parameter Order field [244] and an (Increment/Decrement) or Unit +/− field [238]. The buttons at bottom of the Auto-Cycle pane, or their corresponding ASCII keyboard shortcuts, may be used to Start/Stop Auto-Cycle [240/241], Step Advance [242], or Capture Parameters [243]. A rate field [245] allows adjustment to the Auto-Cycle rate of auto-increment.

4. Blending of Control Sources

What is Real-Time Controllable?

In a word: EVERYTHING. Since we do not include here a complete list of all parameters for all objects, we summarize below the kinds of parameters that can be controlled. By the latest count (not yet including the recently added video effects) there are at least 784 separate, uniquely “animatable parameters” in the 3D Visualizer. Obviously, the possible combinations and permutations of exploiting these in various Scenes sum to a substantially huge combinatorial number. All parameters of all objects are controllable by being routed from any control blend combination(s) of audio, keyboard/mouse, MIDI and Oscillators as well as Control Recordings.

Camera [42]
a. Camera (perspective on the scene) Position, Orientation, and Angle.
b. Field of View, Speed, Spin Speed, and Tilt.

Models [47]
a. Opacity (transparency).
b. Bitmap, Mask, or Texture.
c. Position, Orientation and Scale (separately in X, Y and Z.)
d. Geometric morphs or alterations that depend upon the particular Model, such as (in generic terms here) stretch, squash, distort, stellate, collapse, twist, contort, etc.
e. Texture mapping onto the model: position, orientation, mirroring, splitting, etc.
f. Segments, Number of Bands, Sides, Spirals, Curvature, Radius, Poly Order and Tiles.
g. “Magic” parameters that are unique and indescribable, and must be tried for each model that has them, to understand their effect.
h. Sprout (particle system) Mode, Range, External Force, Speed, Angle, Life Time, Scale and Opacity. In most cases, each of those parameters has a separate Start and End and/or Min and Max.
i. Key Frame, Speed, and Loop Mode for such as Wild Tangent Actors.

Textures [58]
a. Which image file is used as a Bitmap.
b. Which image file is used as a Mask.
c. Multiple images on multiple layers.
d. Scale, Position, Origin, Orientation of Bitmaps.
e. Changing the Type such as Simple, Reflection, Reflection Fast, Refraction, and Refraction Fast.
f. Changing the Blend method such as Blend, Replace, Multiply, Add and Weighted Add.
g. Frequency, Resampling, Point, Origin, Scale and Opacity for special textures like Waves.
h. Video Filename, Video Capture Mode, Rate, Position, Loop, Alpha Mask, Resampling, Opacity, Scale, Origin, Type and Blend for Video Textures (including for two-layer video textures!)

Animators [44]
a. Master Multiplier (overall strength of whatever is animated), and Offset applied to whatever control values.
b. Oscillator Multiplier, Depth, Type, Phase, and Speed.
c. (PC) Keyboard Multiplier, Key name (location), and Keyboard ADSR values.
d. MIDI Multiplier, MIDI Message Type, MIDI Channel, Value Range, and V-ADSR values (in other words, even changing these on the fly.)
e. Audio Multiplier, number of Audio Bins (how spectrum is divided up); Smooth, Force, Attack, and Decay.

Lights [55]
a. Color and Type.
b. Constant Attenuation, Linear Attenuation, Quadratic Attenuation, Umbra, and Penumbra.

Interpolators [225], Sliders [226] and Keyboard Sensors [227]
a. Values and Keys (common parameters used for many types of interpolators).
b. Positions in X, Y and Z.
c. Red, Green and Blue values for such as the Color RGB Interpolator.
d. Hue, Saturation and Brightness values for such as the Color HSB Interpolator.
e. Scene Name for Scene Switching.

Blending Types of Control

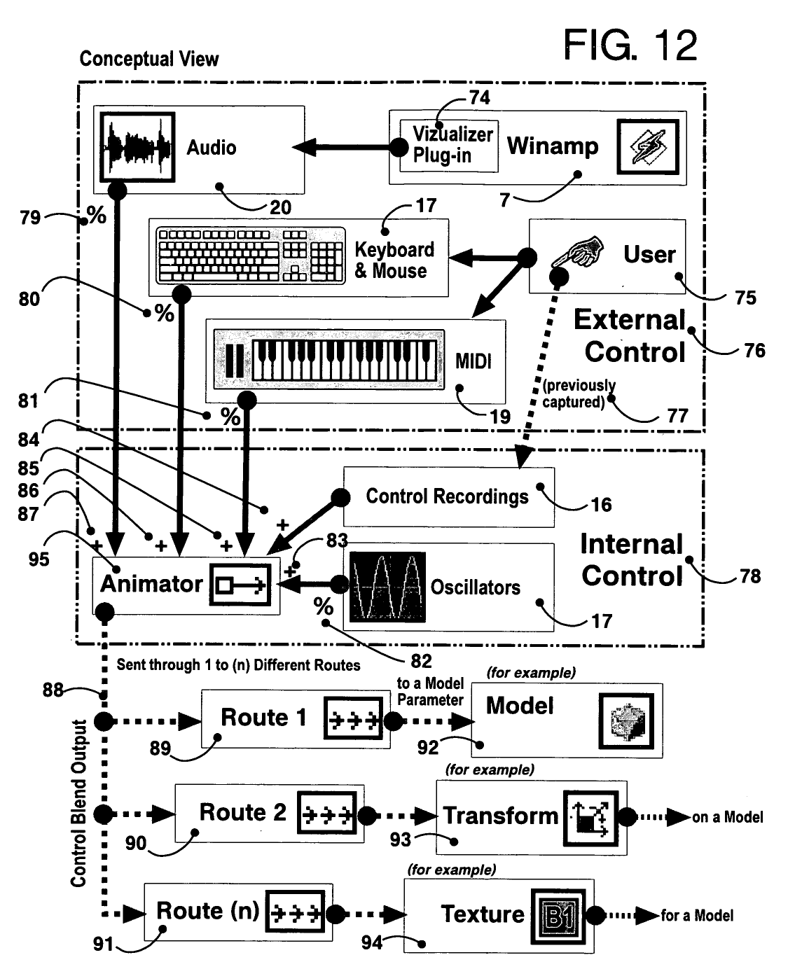

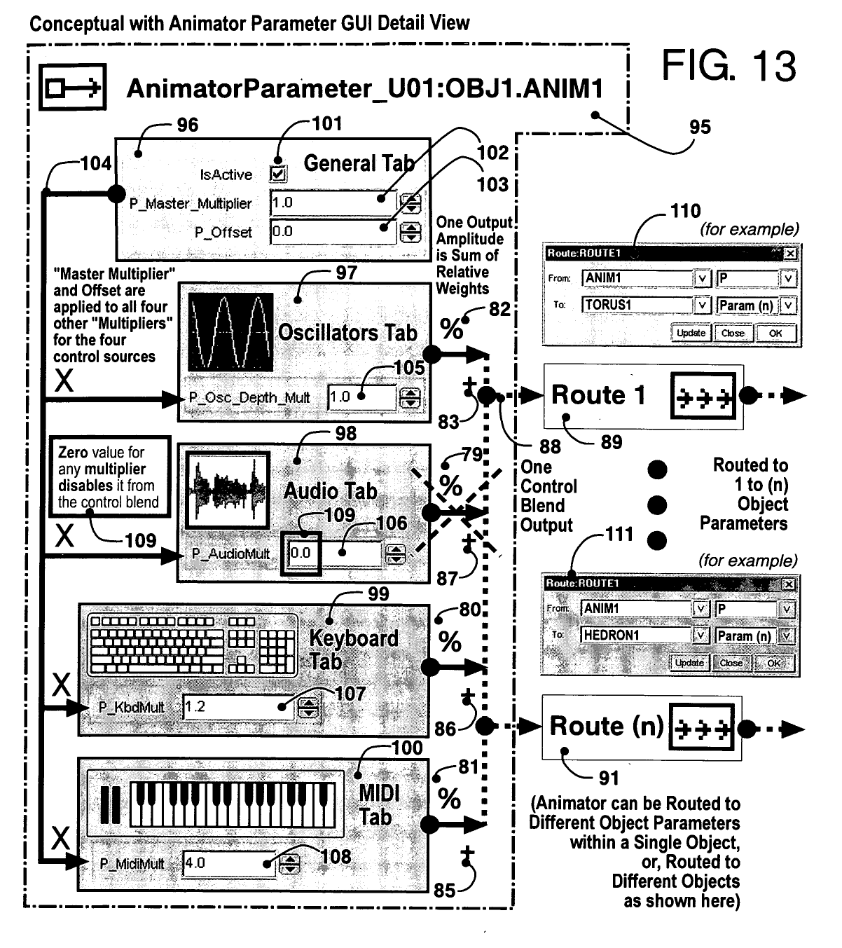

Refer to FIG. 12. For any 3D Visualizer scene, there are multiple live or external [76] and recorded or internal [78] sources that may control how models, textures and effects behave and animate. They are: Internal Oscillators [17], Audio [20] (by means of a “plug-in” [74] for the Winamp [7] digital media player software application), player [75] actions using PC keyboard [17] (and mouse). MIDI input devices [19] such as a piano keyboard, pressure pads, faders or any type of MIDI controller device may be used. Also, a Control Recording [16] may also be applied in the blend, which previously recorded actions such that during playback it re-generates all results from the previous live actions from Audio [20], PC keyboard/mouse [17], and/or MIDI triggers producing their corresponding MIDI protocol channel messages [19]. For any single Animator [95], (the most generalized and configurable Animator Type being called AnimatorParameter_U01 detailed in FIG. 13), these are arithmetically “blended” [79,80,81,82] and [83,84,85,86,87] into a single weighted output value [88]. This Control Bend Output from the Animator [95] can then be Routed [89,90,91] to nearly any Object(s) [61] or Object(s)' parameters [63] employed in the scene, by means of the Power Editor's scene nodes graph [39].

Overview of Blending Control Sources

FIG. 12 illustrates the general idea. The particular Model [92], Transform [93], Texture Object [94] and Routes [89,90,91] shown (fed from the Animator [95] output [88]) are arbitrary examples and are shown here for an overview illustration of the 3D visualizer interpreter nodes graph topologies. FIG. 12's generic example shows one Animator control blend output [88] to multiple Routes [89,90,91], thus exhibiting an input/output transfer function having a one-to-many mapping scheme.

Control Blending Detail

Refer to FIG. 13 for a more detailed look at exactly how the AnimatorParameter_U01 [95] can be variably setup to “Blend” any combination of the real-time sources of control [97,98,99,100], into its single output value [88]. The first thing to understand is that the General Tab's P_Master_Multiplier [102] and P_Offset [103] values affect all of the four input types, by multiplying against the individual Multipliers [105,106,107,108] values. The relative values of each the four individual Multipliers in turn determines the both amplitude or “amount” of each and thus its degree of apparent visual effect in the Scene, and thus also the relative “weights” [79,80,81,92] of each of them in the combined Control Blend Output [88]. If a scene author sets any of the Control Sources' individual Multipliers [105,106,107,108] to a value of zero [109] that disables that control source (for this Animator [95] only.)

Divided (Allocated) Control Ranges

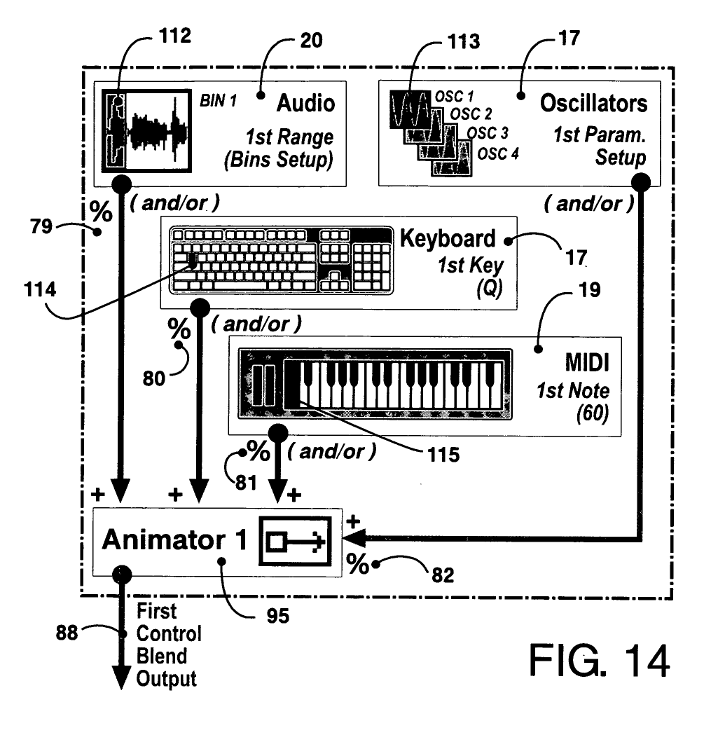

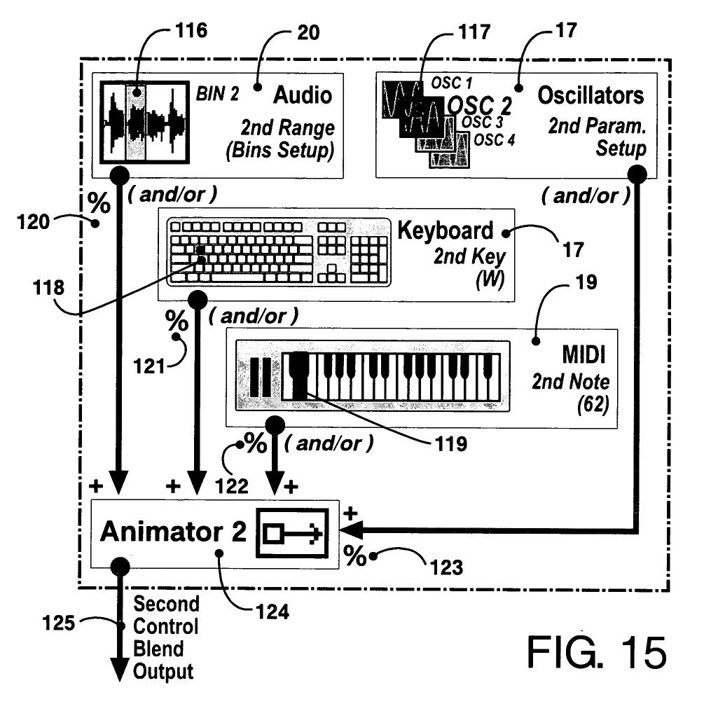

Refer to FIGS. 14 and 15. We illustrate therein how a scene author can “divide up” the “control range” or “control space” of each source [97,98,99,100] for this animator [95] only. This example shows how each control blend (first [88] and second [125] control blends only are illustrated) use respectively just one oscillator [113,117], and/or one frequency range of the audio spectrum [112,116], and/or one of a few PC keys [114,118], and/or a few MIDI Notes [115,119].)

Much of the level of visual clarity, fun and “rich aesthetics” achievable in crafting interactive 3D Visualizer scenes—especially when combining all control sources including MIDI control—comes in this fashion:
a. How a scene author divides up both the relative weights of the different types of control for any given Animator->Route->Object situation. For each such Animator in a scene, one decides exactly both what control sources are active, and how much each of them contributes to the total Control Blend Output value.
b. How one divides up each of the individual control spaces between animators. It takes a bit of strategizing and planning what one is intending to accomplish in the scene (who does what). Next we're going to illustrate next exactly how to go about this.
c. One can even animate the way these control sources are blended together (including if they are enabled or disabled) under real-time control, by Routing another animator to control the AnimatorParameter_U01's individual Multiplier parameters.
   Example #1 of Divided Control Ranges

FIG. 14 illustrates an example of how to begin to divide up the control range for each the various sources, for say the first such Animator [95] one has in a Scene: What we show in FIG. 14 is:
a. The Audio [20] coming through Winamp [7] has been reduced to a “slice” of the audio spectrum [112], by setting up a number of audio frequency “bins” and specifying which particular bin(s)' amplitude contributes towards a summed amplitude value to this Animator's output; (note: even frequency bin definition fields are animatable parameters);
b. The internal Oscillators [17] have been setup in a way that only one of the four are contributing to the Animator's output [88] value, namely the first [113] or OSC1;
c. The PC Keyboard [17] has been setup so that only one key, the Q key [114], will contribute to the Animator's output [88];
d. For MIDI [17] we're using (a MIDI piano keyboard's) Note ON Message Type, and we've limited the setup for Animator1 [95] so that only a single note, the “C3” note name or note number of 60 [115] will contribute an effect into the Animator's output [88].

Now consider the additional factor of how these four might blend together, for any given Animator. As a general guideline, we suggest this:
a. Always have one control source set substantially higher (have a greater Multiplier value) than any others;
b. If one blends in oscillators with any other control sources, have the Oscillator Multiplier very low, to keep it subtle and maintain the distinction from live sources having greater amplitude.
   Example #2 of Divided Control Ranges

FIG. 15 illustrates an example of how to divide up the control range for the various sources, for say the Animator #2 [125] in the Scene, and to clearly distinguish its contribution from that of the first Animator.

What we show in FIG. 15, as contrasted from the FIG. 14 “Animator #1” example, is:
a. The Audio [20] coming through Winamp [7] has been reduced to a different “slice” of [116] the audio spectrum, by setting up a number of audio “bins” and specifying which particular bin(s) contributes a value to this Animator's output [88], to cover a different audio frequency range as compared to that of the Animator #1 setup;
b. The internal Oscillators [17] have been setup in a way that only one of the four are contributing to the Animator #2[125] output value, namely the second [117] or OSC2;
c. The PC Keyboard [17] has been setup so that only one key, the W key [118], will contribute to the Animator #2 [125] output;
d. For MIDI [19] we're using (a MIDI piano keyboard's) Note ON Message Type, and we've limited the setup so that only a single note, the “D3” note name or note number of 62 [119] will contribute an effect into the Animator #2 [125] output.
   A Typical, Complete Example of MIDI Control Allocation

One can repeat the setup process for as many Animators as desired. At least four to eight are interesting enough to manipulate in real-time. We've found that extremely effective and expressive scenes can be created using as many as dozens of different Animators, each one setup carefully for each of its control sources in just the kind of approach illustrated here.

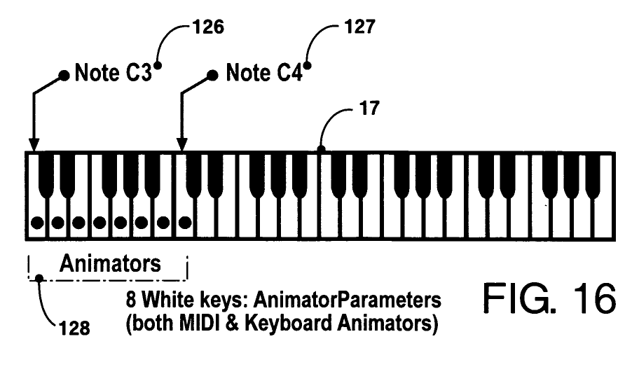

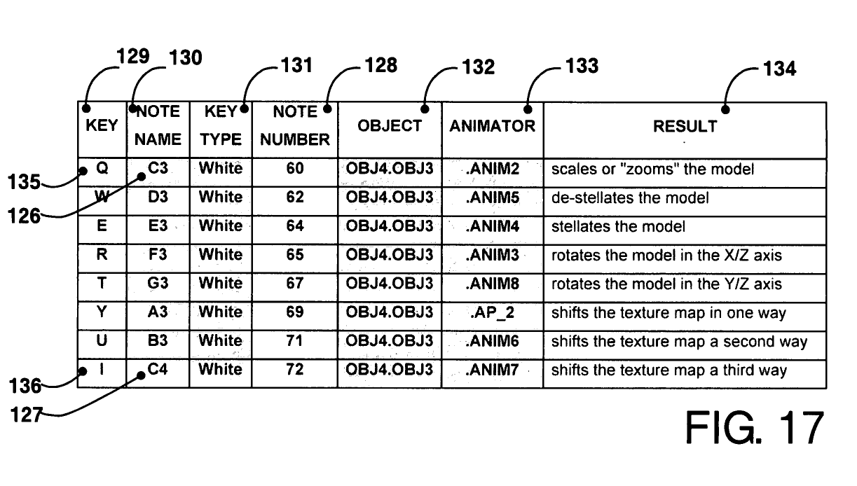

FIG. 16 and the FIG. 17 table together illustrate an example allocation over a range of MIDI piano controller keys. Using only the “white” keys of the piano: eight Animators [128, (all for one OJBECT OBJ.OBJ3) ranging from Note C3 [126] to Note C4 [127] respond to these respective Keys, and in this example all these Note ON/Note OFF values are received on MIDI Channel 1. It is extremely important to understand that all these Animators [133] are fully functionally “polyphonic”; that is, correlating to the polyphony of the triggering Note messages, the Animators' behaviors are fully simultaneous and interpenetrating in the 3D output response. Any combination of Animators [133] can be active at one moment, and that combination in practice is most often in a constant state of change. To put it another way, in the example shown, the visual effect of any one ASCII or MIDI key [129,130] and its associated Animator [133] is clearly self-evident (in most cases) no matter what other Animators may also be active at the same time and that are cycling through their V-ADSR curves, all typically in variably overlapping fashion over time depending upon whatever style of key play.

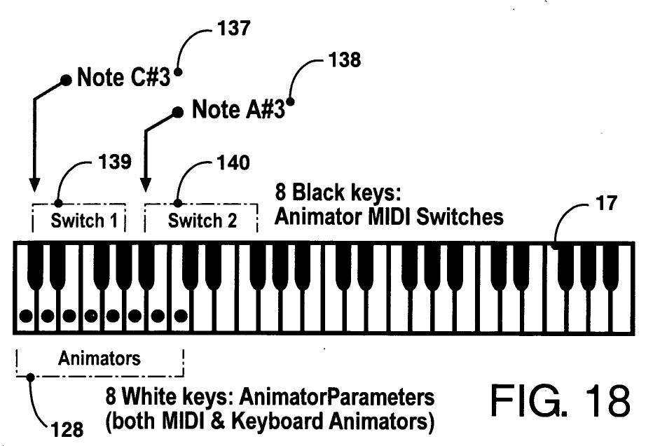

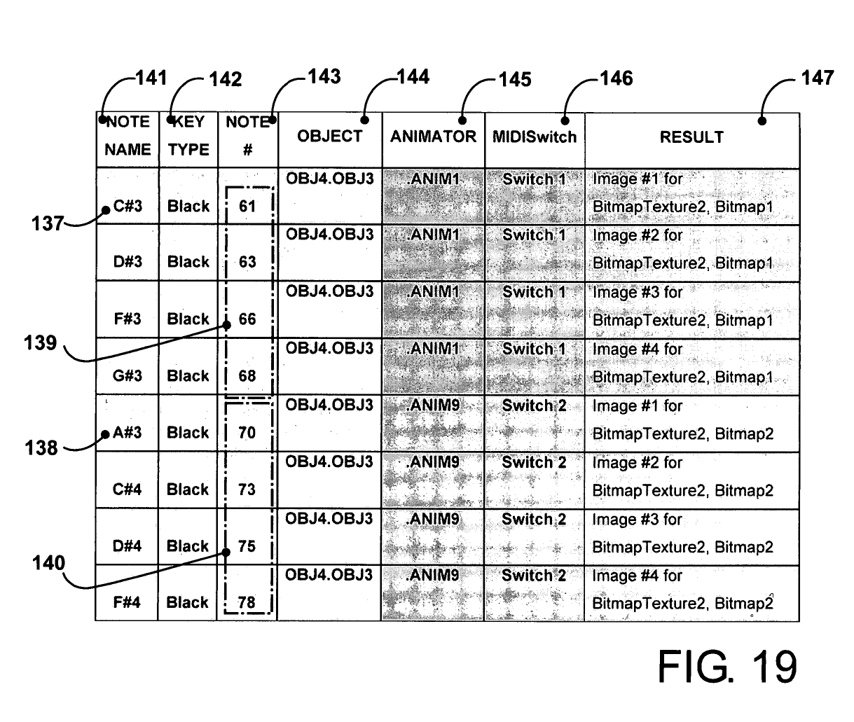

Refer now to FIG. 18 and the FIG. 19 table, wherein we further elaborate the example, packing more Animators into the allocated control spaces. We can further expand the scope of real-time control, by also adding a second type of Animator [139,140] called MIDI-Switch [146], to swap textures [147] (bitmap images) applied to Model(s) in real-time; even rapidly, continuously and while the model is also simultaneously animating according to the geometry modifiers and texture position shifters illustrated in FIGS. 16 and 17. Two such switches [139,140], comprising four alternative bitmap textures each, are shown in the example.

5. Flexibility of Routing

Auto-Builder for Assisted Scene Construction

An “Auto-Builder” function, available when Scene Nodes/Object Parameters are selected, assists by appropriately auto-inserting Nodes and auto-routing Scene Objects together.

Routing Animators to Different Types of Objects

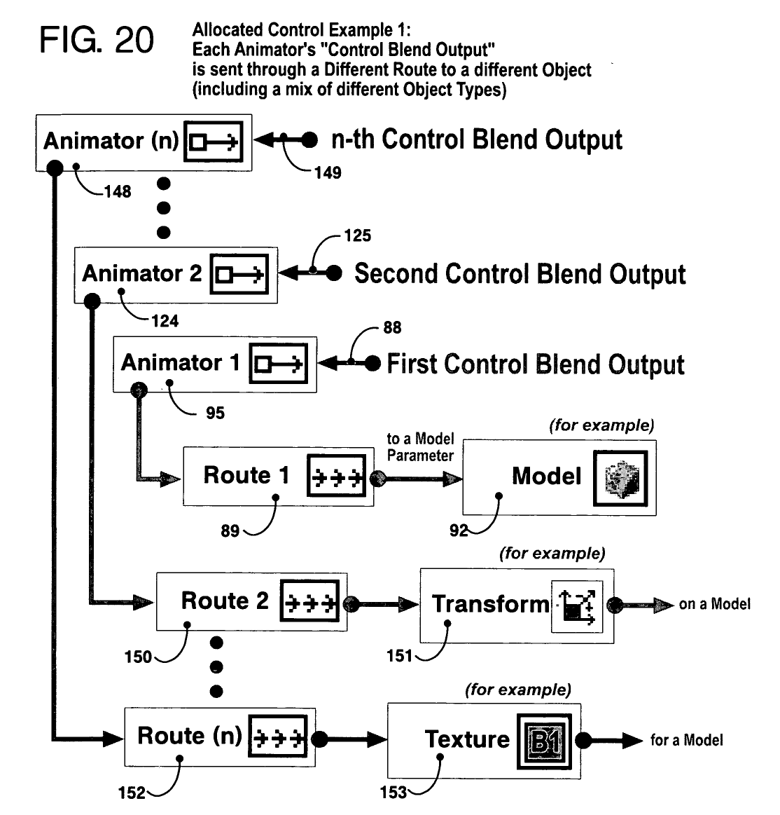

FIG. 20 shows how an example scene can Route [89,150,152] several Animators [95,124,148], each one outputting its own control blend [88,125,149] into one of many Objects [92,151,153] including different Types of Objects. This is an example of a Many-to-Many case for input-output transfer function routing.

Routing Animators to Different Parameters of the Same Object

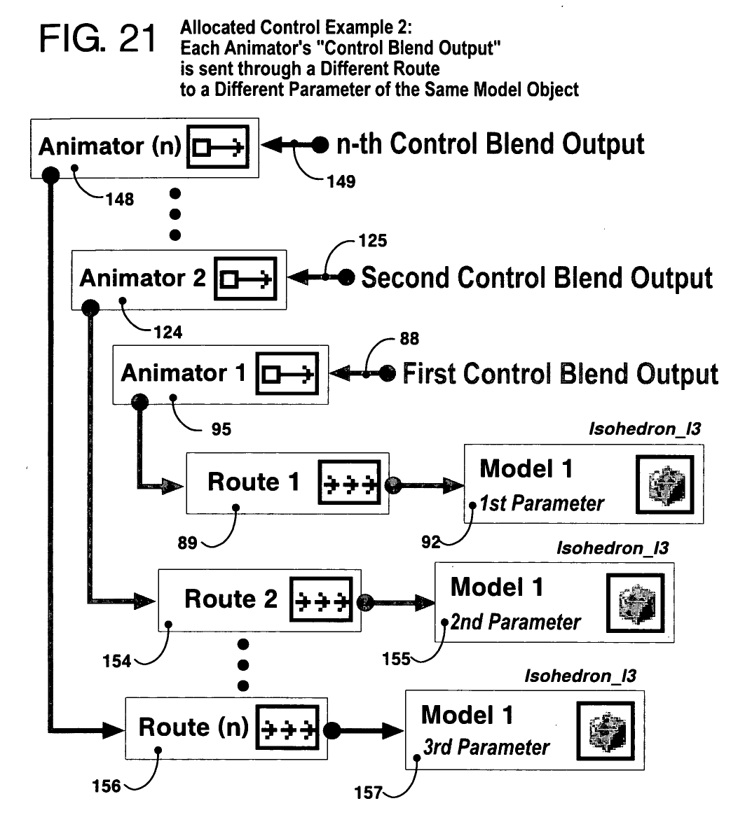

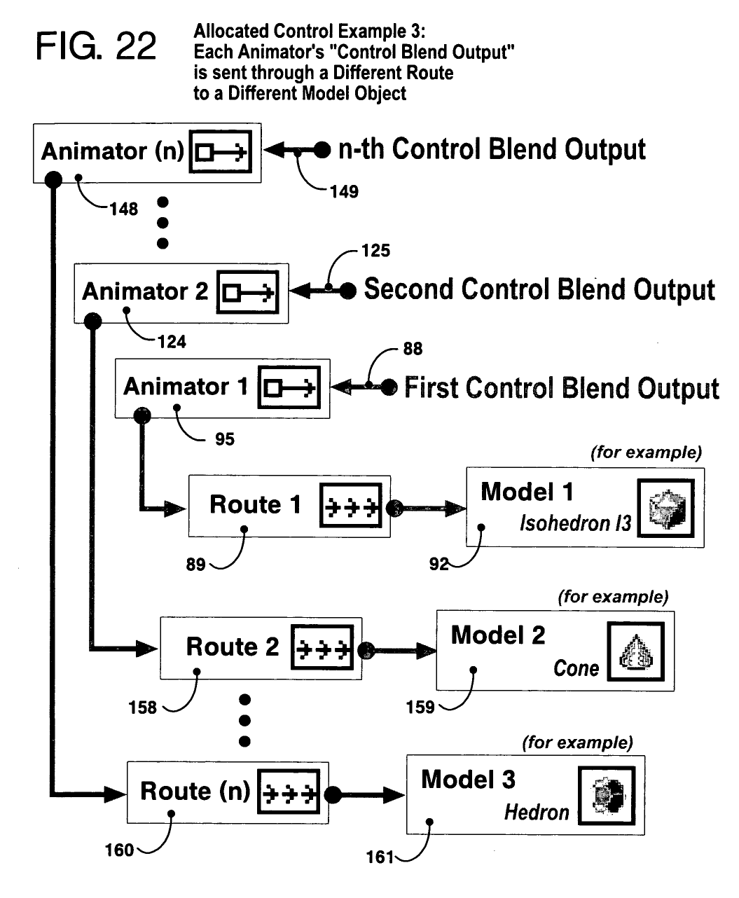

One can Route several Animators into many different parameters in a single Object. FIG. 21 shows how a scene could set up each of three Animators' Control Blend Outputs [88,125,149] to respectively Route [89,154,156] to three different parameters [92,155,157] of the same 3D Model 1. While in some sense this may be viewed as another Many-to-Many case, since the parameters are of the same model, the visual impact is more of a Many-to-One case of input-output transfer function routing. Furthermore, while not detailed in the FIG. 22, such a Scene can also optionally be setup so that a first Model Parameter [92] only responds to Audio animation [20], a second Model Parameter [155] only responds to PC keyboard/mouse [17] actions and one MIDI message range [115], a third Model Parameter [157] only responds to a different MIDI message range [119], and a fourth Model (not shown) might only respond to Internal Oscillators [17].

Routing Animators to Different Models

FIG. 22 shows how a scene could set up each of three Animators [95,124,148] Control Blend Outputs [88,125,149] to Route [89,158,160] to three completely different 3D model objects such as an isohedron [92], cone [159] and hedron [161]. FIG. 22 illustrates another example of a Many-to-Many case for input-output transfer function routing.

Multiple Control Sources, Each Exclusively Affecting Different Objects

Furthermore, while not detailed in the FIG. 22, such a Scene may also optionally be setup so that a first Model [92] only responds to Audio animation [20], a second Model [159] only responds to PC keyboard/mouse [17] actions and also one MIDI message range [115], while a third Model [161] only responds to a different MIDI message range [119], and even a fourth Model (not shown) might only respond to Internal Oscillators [17].

Multiple Players Controlling Different Objects

The approach illustrated above for FIG. 22 is very effective for multiple MIDI players. With MIDI, you can do this by making the MIDI Channel parameter (P_MidiChannel) the same for all Animators Routed to a single Model. Do this as follows:
a. First, choose the various Parameters within each Model to be quite different from each other, such as scale, spin X, spin Y, stellate, de-stellate, and so forth.
b. Allocate the same type of Parameter for a given Animator (such as scale) to the same MIDI Note number, and do this to however many Models (and thus MIDI Channels) are in your scene.
c. Make Animators for different Models' in the scene all respond to different MIDI Channels.

This has the wonderful result as follows. Each player on a different channel (like two keyboard players), playing the same key (like Note C3) will experience a similar animation effect as the other player—however, the two players will induce this similar effect (like scaling) on their own unique Model in the scene.

Routing Several Animators to Position/Orientation Transforms on the Same Model

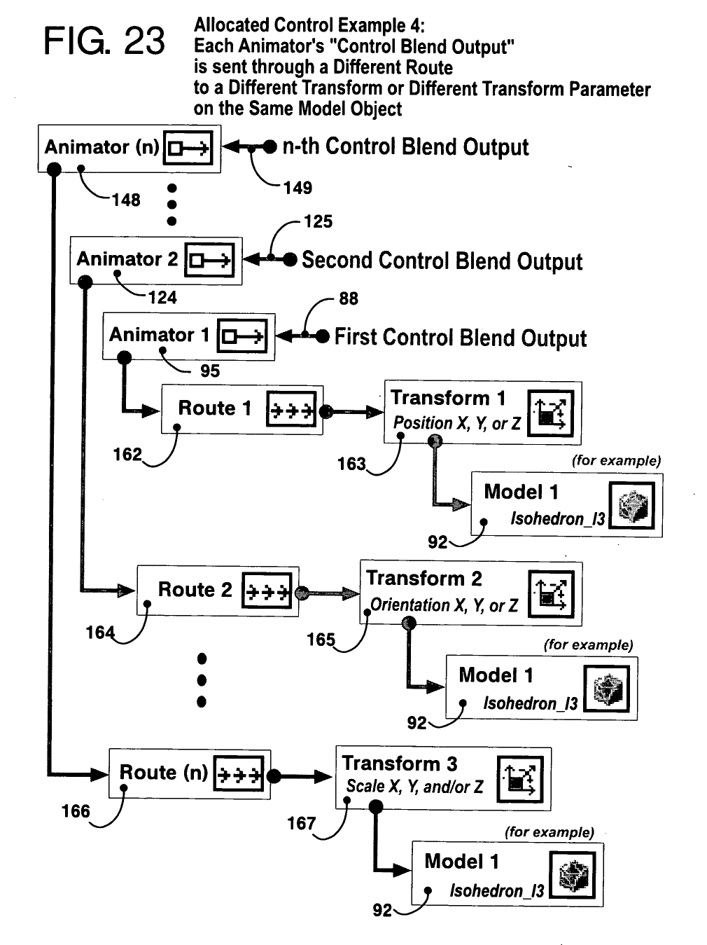

FIG. 23 illustrates another example scene structure, which sets up one Animator [162] to shift position [163] of a Model 1 [92], another Animator [124] to spin the same Model 1 [92] around the X/Z axis [165], and another Animator [148] to scale [167] the same model [92]. While in some sense this may be viewed as another Many-to-Many case of input-output transfer function Routing, since the various Transforms [163,165,167] are of the same model, the visual impact is more of a Many-to-One case of input-output transfer function routing.

One Animator Control Blend Routed to Multiple and Different Parameters of One or More Objects (Models)

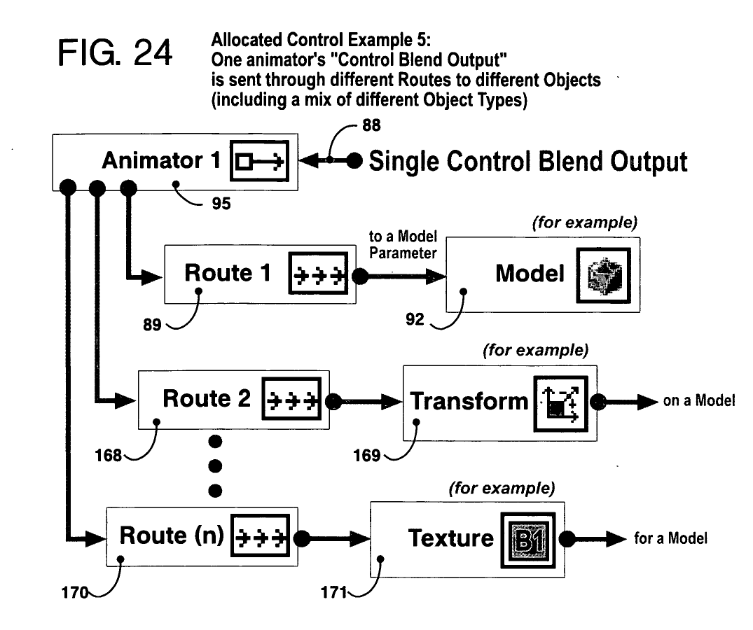

FIG. 24 illustrates how one Animator [95] may be Routed [89,168,170] to various parameters of different Models [92, 169, 171]. This is clearly a One-to-Many case of input-output transfer function Routing.

One Animator Control Blend Routed to Multiple Different Parameters of One Object (Model)

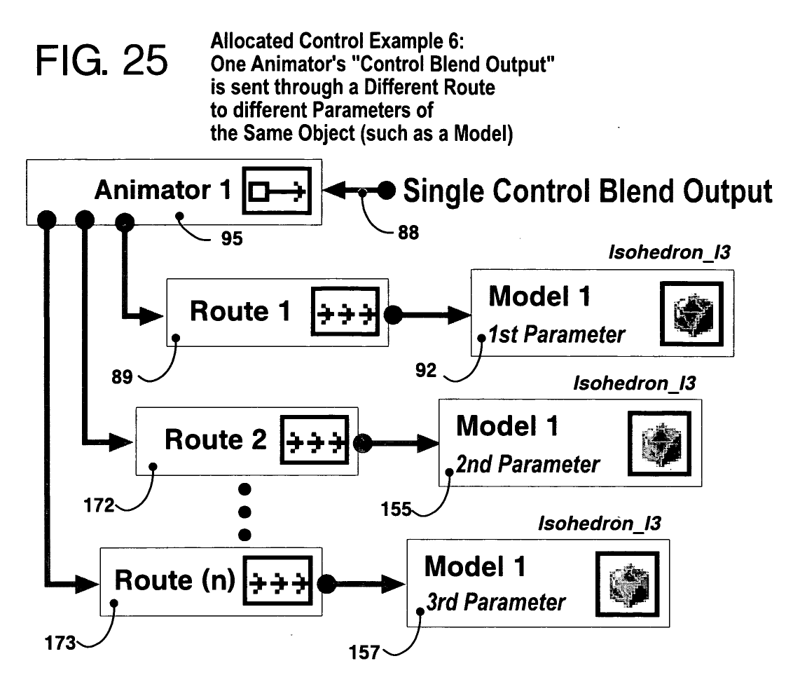

FIG. 25 shows how one Animator [95] may be Routed [89,172,173] to different Parameters [92,155,157] of the same Model. While in some sense this may be viewed as a One-to-Many Routing case, since the Parameters are of the same one Model, the visual impact is that of a One-to-One case of input-output transfer function Routing.

One Animator Control Blend Routed to Multiple Object (Different Models)

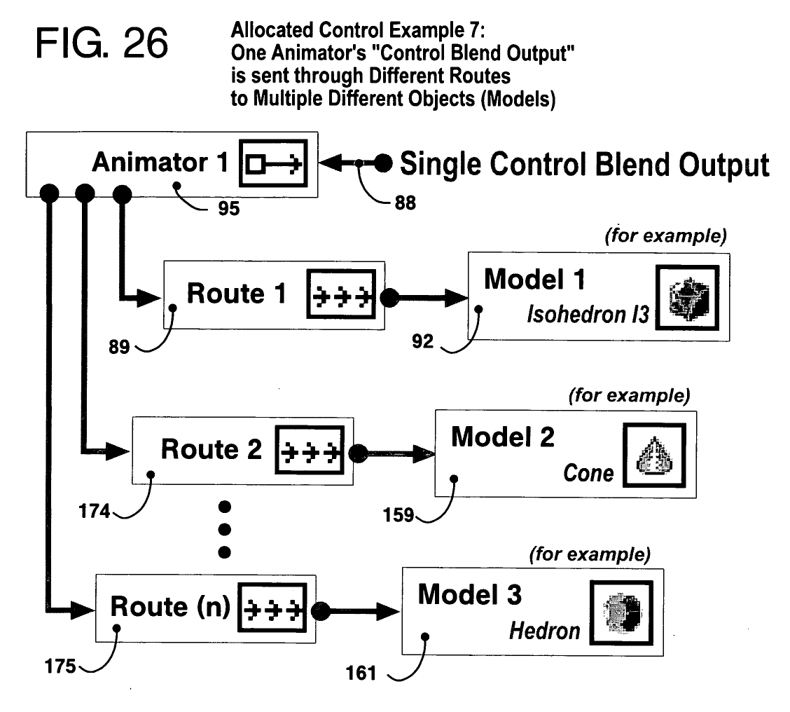

FIG. 26 illustrates how a scene may be setup so that one Animator [95] can also be Routed [89,174,175] to the same or similar parameter on multiple different Models [92, 159, 161] simultaneously. This is an example of a One-to-Many case of input-output transfer function Routing.

6. MIDI Implementation Details

We include details of the 3D Visualizer's MIDI implementation, since it is integral to conveying the power of the invention.

MIDI Maximizes Advantages of the 3D Cybernetic Visualizer

When not using any MIDI devicesv [19] with the 3D Visualizer, this leaves only with PC keyboard and mouse [18] actions (including on-screen blue Keyboard Animator buttons and interpolator sliders). These one can do while the music plays, while hearing whatever music is playing through Winamp [7]. For the most expressive range of interactive control, however, MIDI is really the best way to go. This is because, compared to any PC keyboard, there are several huge advantages to using any type of MIDI controller for input into the 3D Visualizer:

MIDI Polyphony

On most PC keyboards [18], one can only get a simultaneous result holding down two to four keys at most. With MIDI controllers [19], on the other hand, one can simultaneously hold down any combination of keys or pads (notes) up to the maximum “polyphony” of the device, which these days is most often 32, 64, or even more. That means, using MIDI controllers one has a vastly greater set of combinations of animator visual states.

Multiple Distinct Human Players

With MIDI controllers, one can setup multiple people jamming together at the same time, as we show in some of our example setups. One can setup each MIDI input device on a distinct MIDI Channel, and setup each channel wired to different 3D Visualizer Objects and/or different 3D Visualizer animators. (One can also accomplish the same thing by establishing a convention of allocating certain Note ranges or “splits” between players, which we illustrate in FIGS. 16, 17, 18 and 19. Either way, one will see visually in the scene clearly who (which player) is doing what. There is not an easy way to setup multiple PC keyboards simultaneouly on the same computer (at least for one instance of the visualizer application under one OS instance), and even if one could (such as by using virtualization techniques), or one somehow networked players on multiple PCs, there would probably be no way to easily distinguish between their respective modulation impacts on the scene. Everyone would be working the same animators and one would have no way to distinguish different players' actions in 3D Visualizer Scene animations (which would be confusing.)

MIDI Notes On/Off Velocity

MIDI controllers usually have variable initial key pressure sensing termed “velocity.” What this means is, MIDI keys or pads detect how hard one presses on them, and as a result one gets added expression. A 3D Visualizer animator unfolds its result only to a degree corresponding to how hard one pressed the key(s) or pad(s). PC keyboards have no velocity aspect whatsoever, so clicking them will always result in the animator ramping up to its full maximum value (unless one releases and hits a key again quicker than the animator can reach its maximum value. In this way, MIDI velocity has a huge range of subtle expression (typically 127 distinct levels of velocity), whereas PC keyboards have only one. In musical terms, velocity corresponds (generally) to loudness (although many devices also have timberal differences for different velocity). in 3D Visualizer terms velocity has a similar meaning, in that it determines how “visually loud” or how far the animator unfolds in whatever function it is setup to do. (Sometimes there is an optional way to defeat variable velocity such as with the Akai MPD-16 “Full Level” button; in this mode the device will cause MIDI animators to operate similarly to the PC keyboard—with regards to velocity anyway. The 3D Visualizer fully supports Note Messages [185,186] including velocity.

MIDI Aftertouch

Many MIDI devices have the ability to continue to sense varying pressure after the initial key press. Polyphonic Aftertouch [187] can be used in the 3D Visualizer for great subtlety of expression in visual results. There is certainly nothing like this available from PC keyboards.

Continuous Controllers and Pitch Bend.

You'll find at least one continuous controller on most any keyboard, the mod (modulation) wheel, and usually a pitch bend device as well. Some input devices even have a number of continuous controllers such as knobs and faders. Continuous Controllers allow for fine-tuned control including sliding through values, and keeping them at one level then later changing it again. Again, there is nothing like this on PC keyboards. The 3D Visualizer supports both Control Change [188] and Pitch Bend [191] messages.

No Auto-Key-Repeat Issue with MIDI

On some PC keyboards, holding down an alphanumeric character key (A, B, C . . . ; 1, 2, 3 . . . ; etc.) triggers the keyboard's auto-repeat in such a way as the visual 3D Visualizer result is distracting and incomplete. Each auto-repeat, since they happen so quickly, in most cases (depending on your Keyboard ADSR settings) interrupts the full extent of the animator's result so you never get there (while holding a key down, that is). To see if this is true for a given keyboard, we compare the result for any animator between holding down your PC keyboard vs. mouse-clicking a blue Keyboard Animator button on-screen. MIDI controller devices have no such “auto-repeat” function to contend with, (except such as MIDI drum machines and MIDI sample loopers specially configured to do so.)

Human Factors.

Playing rhythmically for a length of time on adjacent PC keyboard keys can be relatively tiring to the hands, compared to playing almost any kind of MIDI piano or MIDI drum pad device. The alphanumeric keyboard ergonomics were designed around an average sequential alternation between hands when typing normal text with the QWERTY arrangement. However, when repeatedly using immediately adjacent keys (as in a row of Keyboard Animators or Keyboard Switches) for a while, this alternation pattern is broken, and instead the hands can begin to feel cramped.

“Synesthesia”

MIDI greatly expands the applications and variations of synesthesia resulting from use of the 3D Visualizer, bringing a number of advantages to interactive multimedia in particular. We discuss this further in the Synesthesia section below.

Supported MIDI Messages

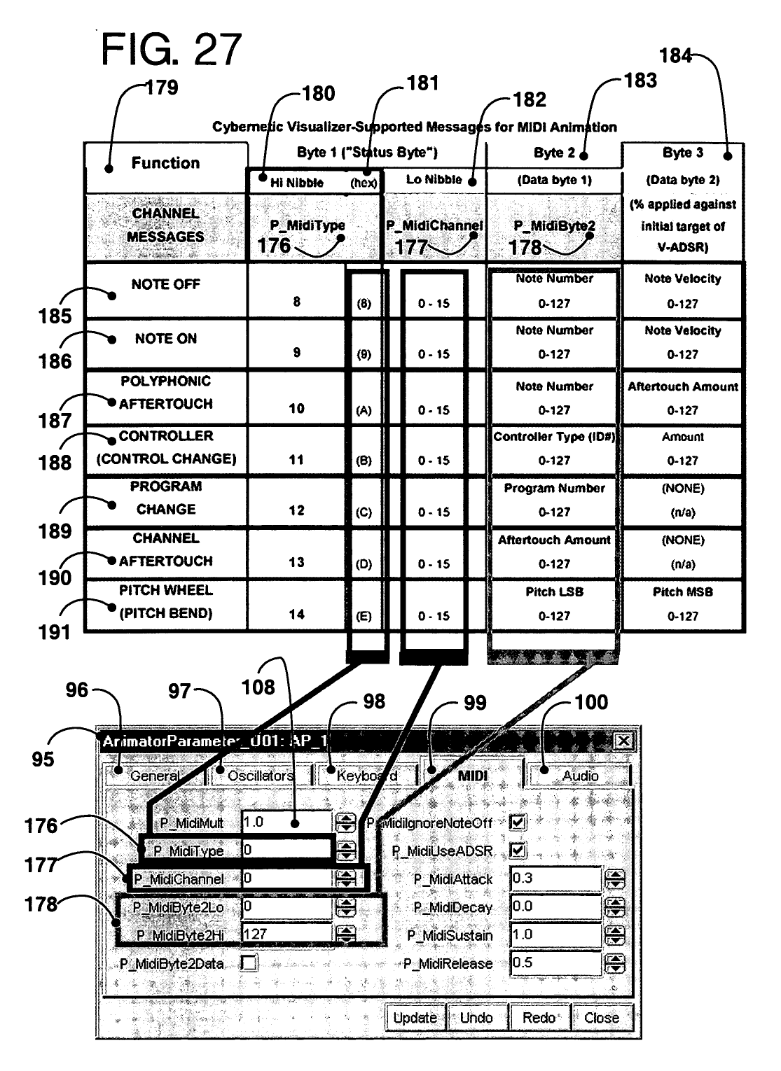

FIG. 27 illustrates the five types of MIDI Messages that the visualizer interpreter currently supports for Animators: Note OFF [185], Note ON [186], Polyphonic Aftertouch [187], Continuous Controllers (Control Changes) [188], and Pitch Bend (Pitch Wheel Control) [191]. They are all Channel Messages (as compared to the System Messages for things like MIDI clock.) We have also shown where you will enter these values into the 3D Visualizer GUI, namely in the parameter fields P_MidiType [176], P_MidiChannel [177] and P_MidiByte2Lo/P_MidiByteHi [178] that are found under AnimatorParameter_U01's [95] MIDI Tab [99].

MIDI Program Change messages [189] are also supported. A received MIDI Program Change affects either Jump to Scene change, or a Jump to Playlist Track change (which includes a Scene change along with other elements including associated Control Recordings [16].) MIDI Bank Select MSB/LSB (MIDI Continuous Controllers #0 and #32) are also supported, which messages controls which Visualizer “Scene Bank” or “Playlist” a subsequent Program Change message triggers a Jump to Scene or Jump to Track into.

MIDI Animator Styles

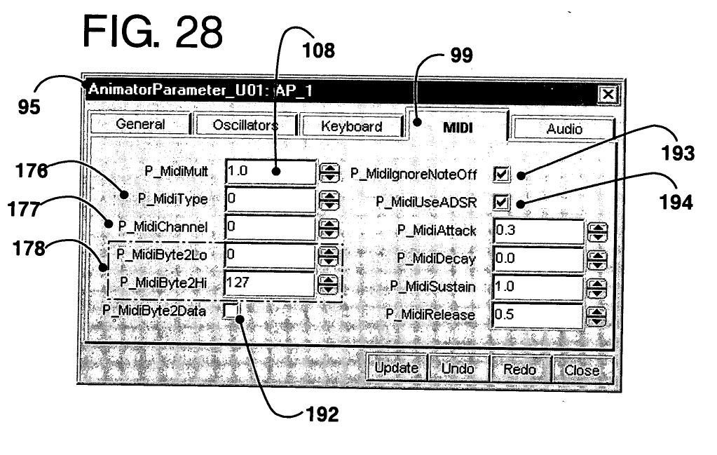

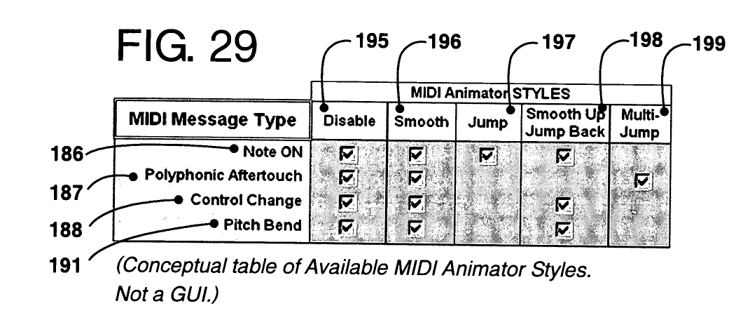

The variations of MIDI Animator “Styles” (of behavior) for 3D Visualizer object animations (modulations) are the result of how one sets up the AnimatorParameter_U01 [95] MIDI Tab's [99] checkboxes [192,193,194] (see FIG. 28). The differences between MIDI Animator Styles namely, Disable Style [195], Smooth [196], Jump [197], Smooth Up Jump Back [198] and Multi-Jump [199] can be quite dramatic. While there are some similarities of a given style across different MIDI Message Types [179], there are also subtle differences. The table of FIG. 29 shows which MIDI Animator Styles are available for each MIDI Message Type, respectively.

The various results for how you combine the three relevant MIDI Parameter Tab [99] checkboxes [192,193,194], for each of the supported MIDI Channel Messages [186,187,188,191], define “MIDI Animator Styles.” Basically, a style is the way the animator behavior (modulation) changes with time: Does it start from where it last was, or always from the minimum value? Does it jump, or ramp smoothly? Does it hold the maximum value, or jump back to minimum? Does it repeatedly jump?

Note ON Styles

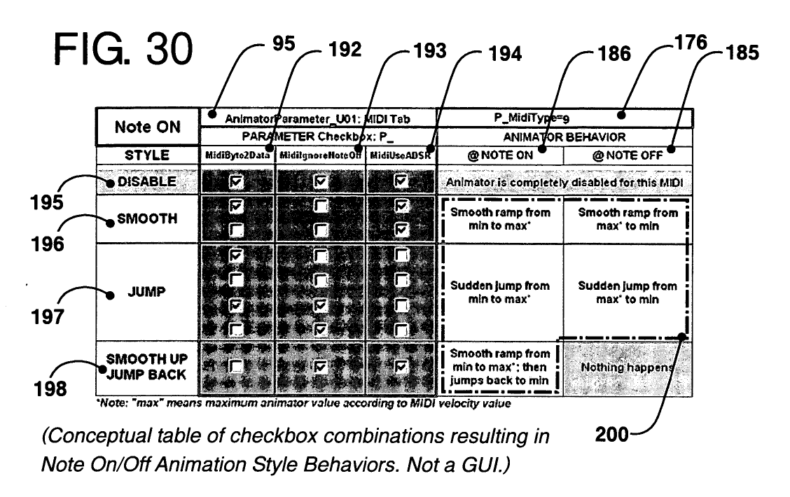

The table of FIG. 30 summarizes the MIDI Animator Styles for all possible checkbox settings [192,193,194] in the AnimatorParameter_U01 MIDI Tab [99] dialog window, for Note ON Messages [176]. The comments [200] in the table annotate the Style of MIDI Animator behavior for each case.

Note OFF

While MIDI Note OFF [185] is shown in the 3D Visualizer-Supported MIDI Messages Table of FIG. 27, in practice it is never setup as the value in the P_MidiType [176] field. Instead, so long as the P_MidilgnoreNoteOff [193] parameter is left unchecked, then receiving a Note OFF (or Note ON @ velocity=0) MIDI message brings the Note ON animator's action to a conclusion (however that is ramped over time according to the MIDI tab's P_MidiRelease [222] value.)

Polyphonic Aftertouch Styles

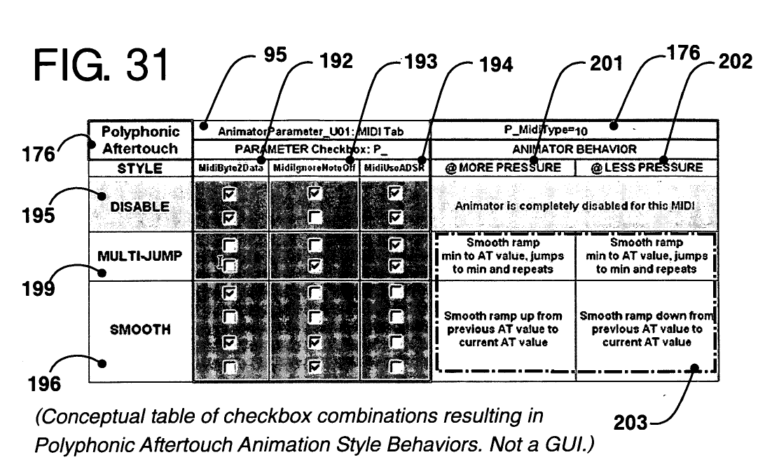

FIG. 31 illustrates the MIDI Animator Styles for all possible checkbox settings [192,193,194] in the AnimatorParameter_U01 MIDI Tab [99] dialog window, for Polyphonic Aftertouch Messages [187]. The comments [203] in the table annotate the Style of MIDI Animator behavior for each case.

Control Change Styles

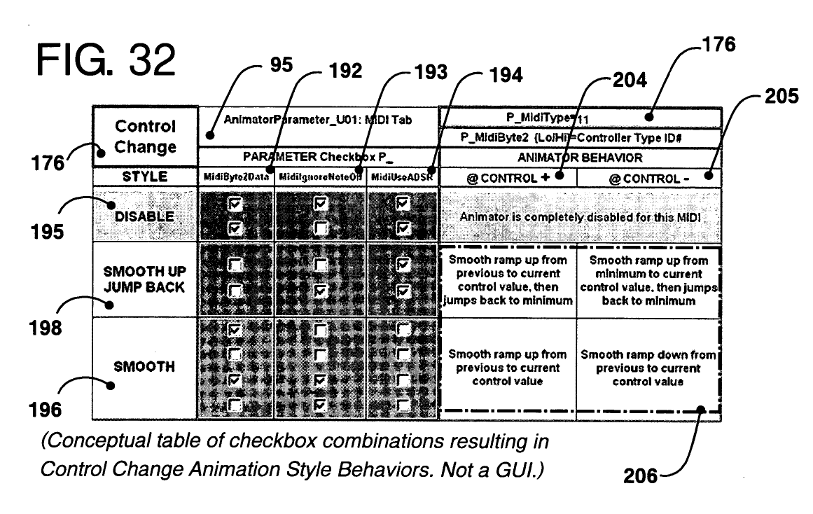

FIG. 32 illustrates the MIDI Animator Styles for all possible checkbox settings [192,193,194] in the AnimatorParameter_U01 MIDI Tab [99] dialog window, for Continuous Controller (Control Change) Messages [188]. The comments [206] in the table annotate the Style of MIDI Animator behavior for each case.

Pitch Bend Styles

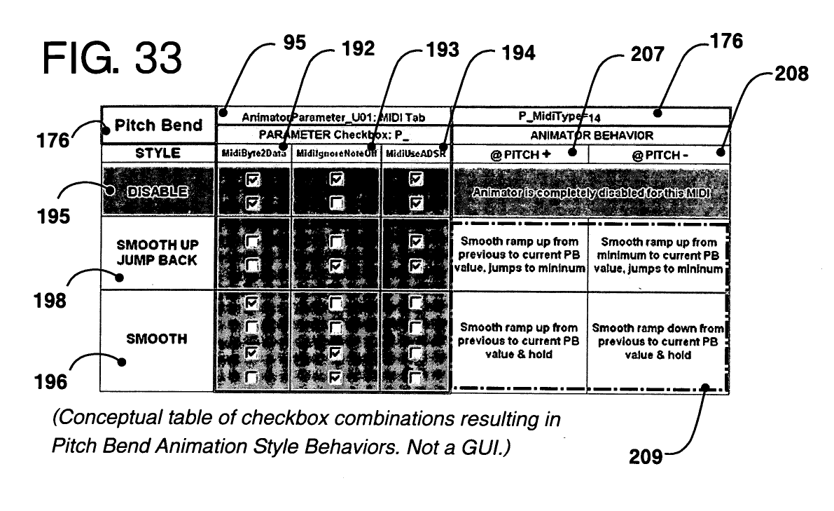

FIG. 33 illustrates the MIDI Animator Styles for all possible checkbox settings [192,193,194] in the AnimatorParameter_U01 MIDI Tab [99] dialog window, for Pitch Wheel Control (Pitch Bend) Messages [191]. The comments [209] in the table annotate the Style of MIDI Animator behavior for each case.

MIDI Animation Graphic User Interface (GUI) Parameters

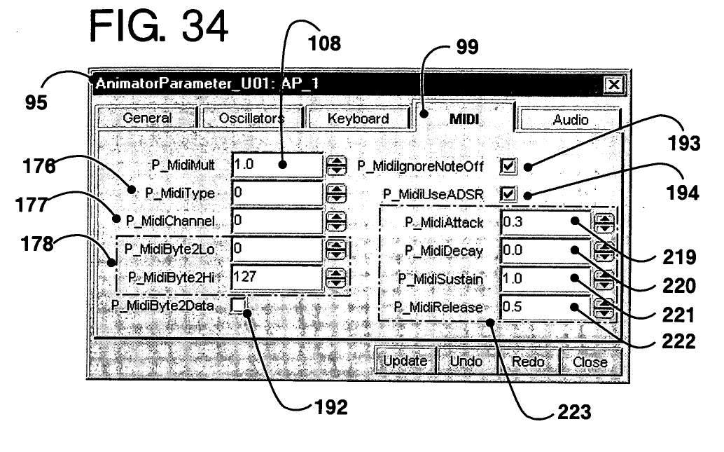

Refer now to FIG. 34.

P_MidiMult [108]

This represents the initial target value for the V-ADSR enveloping effects for the MIDI animation. A value of 0 will mean that one wants MIDI events to have no effect for this Animator.

P_MidiType [176]

This is where one sets the MIDI (Channel) Message Type. The most common that one will probably use are 9 for Note On (this lets one use the keys on your MIDI keyboard to trigger Animator in The Visualizer), and 11 for a Control Change (for using continuous controller sliders or wheels on your MIDI keyboard). The Visualizer also supports Polyphonic Aftertouch and Pitch Wheel (Pitch Bend), and these can be very expressive.

P_MidiChannel [177]

This is where one assigns which MIDI channel one is receiving MIDI messages over for the particular animator. This setting is zero-based, meaning that 0 means the first MIDI channel, 1 means the 2nd MIDI channel, 2 means the 3rd MIDI channel, etc. In MIDI a Channel refers to one of 16 possible data channels over which MIDI data may be sent, per each separate MIDI Port. Since The Visualizer currently recognizes one input port, it is limited to a total of 16 MIDI Channels.

P_MidiByte2Lo [178]

This setting is where one can delimit the lower range of Byte 2 of whichever channel message is chosen to use for the animator. In combination with P_MidiByte2Hi one can setup an animator to be only triggered within a certain range of keys on a keyboard, or a range of Controller Types, or a range of Aftertouch pressure, or even over a range of Pitch. To respond to a single note, a single controller type (such as mod wheel only), a specific aftertouch pressure, or a specific pitch—then one simply makes P_MidiByte2Lo and P_MidiByte2Hi exactly equal.

P_MidiByte2Hi [178]

This setting is where one can delimit the upper range of Byte 2 of whichever channel message is chosen to use for an animator. In combination with P_MidiByte2Lo one can setup your animator to be only triggered within a certain range of keys on a keyboard, or a range of Controller Types, or a range of Aftertouch pressure, or a range of Pitch. To respond to a single note, a single controller type (such as mod wheel), a specific aftertouch pressure, or a specific pitch: simply set P_MidiByte2Lo and P_MidiByte2Hi exactly equal.

P_MidiByte2Data [192]

This check box allows the animator to use Byte 2 instead of Byte 3 for the extent (%) of the first target or initial Attack peak set in your V-ADSR. For Note On, this would be the note number instead of velocity (in other words, the note number would not only determine which animator is active, but would also be substituted for the velocity; (i.e., Note number 60 would act like it also had a velocity of 60, Note 74 like it also had a velocity of 74, etc.). For controllers, this would be the controller type (controller ID#) instead of the control value. For aftertouch, this would be the note number instead of pressure value. For pitch bend, this would be the Pitch LSB instead of the Pitch LSB and Pitch MSB combined. While the “substitute Byte 2 for Byte 3” function is not currently implemented per se, still, how you set this checkbox in combination with the P_MidilgnoreNoteOff and P_MidiUserADSR checkboxes, for a given channel message type, comprises our MIDI Animator Styles that will have a dramatic impact—resulting in the five distinct styles of Disable, Smooth, Jump, Smooth Up/Jump Back, and Multi-Jump.

P_MidiIgnoreNoteOff [193]

For a P_MidiType=9 setting for Note On this check box allows one to ignore the Note Off event when releasing the key or pad. However, it still has an effect even with the other supported channel messages as well.

How one sets this checkbox in combination with the P_MidiByte2Data and P_MidiUserADSR checkboxes, for a given channel message type, determines which of our MIDI Animator Styles (Disable, Smooth, Jump, Smooth Up/Jump Back, and Multi-Jump) will be in effect for the animator's MIDI response.

P_MidiUseADSR [194]

Use this check box to select or de-select whether the V-ADSR envelope settings are applied to the animator. How one sest this checkbox in combination with the P_MidiByte2Data [192] and P_MidilgnoreNoteOff [193] checkboxes, for a given channel message type, determines which of our MIDI Animator Styles (Disable [195], Smooth [196], Jump [197], Smooth Up/Jump Back [198], and Multi-Jump [199]) will be in effect for the Animator's MIDI response.

P_MidiAttack [219]

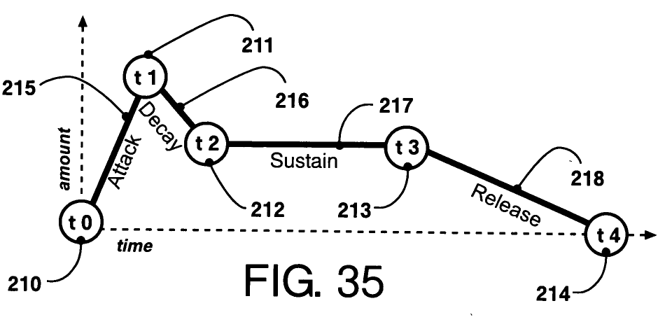

This together with the next three parameters setup the Visualizer's V-ADSR, for a given MIDI-enabled animator. Refer to FIG. 35. P_MidiAttack [219] sets the time duration [215] (t1 minus t0) to pass between receiving the initial message received [210] at time (t=0) until the animator reaches it's “Initial target” amplitude response [211] at time (t=1). The main difference between PC keyboard and MIDI control of the Visualizer Animators, is that MIDI has the additional Byte 3 [184] expression (i.e. note velocity, controller value, aftertouch pressure, or pitch). A PC keyboard driving the Visualizer behaves exactly the same as MIDI messages always having their Byte 3 set to maximum or =127, which translates into the amplitude or amount of the initial “peak” at (t=1), reached at the P_MidiAttack [211] point in time, to be always being 100% of the combined value of the P_MasterMult [102] and P_MidiMult [108] parameters of the Animator. But MIDI has 0-126 values as well, and the effect is that the MIDI Message Byte 3 sets a percentage against the initial target amplitude that would be reached in the PC Keyboard case. (See also the Visual ADSR Section).

P_MidiDecay [220]

This value sets the time it takes to fall from (or, rise to—in the event the P_MidiSustain value is greater than 1.0) from the initial target value [211] at time (t=1) to the sustain amplitude value [212] at time (t=2).

P_MidiSustain [221]

This value sets the amplitude or amount of the Animator's effect, during the time the Animator (and/or Player) is holding the plateau [217] from time (t=2) to time (t=3). This sustain level is maintained until the key release occurs [213] starting at time (t=3). This amplitude value is relative to the animator's total defined “Multiplier” value namely from the combined P_MasterMult [102] and P_MIDIMulti [108] values. If this value is set to 0.5 it is half the maximum amplitude of the combined Multipliers. If this value is 2.0, it is twice the amplitude of the combined Multipliers. Negative numbers are also allowed, and can make for some interesting effects.

P_MidiRelease [222]

This value sets the time it takes the animator effect to fall from its sustain level [217] at time (t=3) to the finish [214] at time (t=4) which is equal in amplitude or amount to the starting point [210] at time (t=0).

7. Visual ADSR

Visual Attack Decay Sustain Release

Refer again to FIG. 35. We developed its V-ADSR technology to manipulate 3D geometry, and a host of other objects and parameters available within the 3D Visualizer, in real-time by envelope generator techniques. Prior to this invention, envelope generators had been primarily used in creating audio synthesizer responses. We took a novel approach in creating a new class of visual response envelope generator or V-ADSR, whose characteristics make it ideally suited for visual manipulation. This technology can transform a simple keystroke or MIDI trigger into a time domain envelope manipulator of the objects and parameters within the 3D Visualizer.

For example, what this does is enable one to create visually rich and complex effects from simple on/off inputs such as computer keyboard so they can emulate much more complex and expressive controllers such as pressure a sensitive keyboards or continuous controllers. This allows one to model and mold the visual envelope to gently ease in an effect with key down, hold the effect at a curtain level as long as you hold down the key and then ease out of the effect when releasing the key. Audio, MIDI and (PC) Keyboard each have unique adjustable envelope generators for each Animator behavior and a large number of these can run and interact with each other simultaneously. The main difference between the (PC) Keyboard ADSR and the MIDI ADSR behavior is as follows. (PC) Keyboard ADSR's initial target amount or amplitude at time (t=1) is set once by the Animator parameter setups on the Keyboard Tab, and is always 100% of whatever the combined Master Multiplier [102], Master Offset [103]and Keyboard Multiplier [107]come out to. This is because a PC keyboard key press is either on or off, down or up; there is no “pressure sensing” by PC keyboards. A PC Keyboard's “key down” always engenders the maximum value determined in the Animator's Keyboard Tab combined parameters, period. On the other hand, In the case of MIDI Messages, the MIDI Message's Byte 3 values are a complete range of 0-127 per each MIDI event. Referring to FIG. 27, this is the case whether Velocity (for Notes), Control Value (for Control Change), Aftertouch Pressure (for Polyphonic Aftertouch), or Pitch (for Pitch Bend). The affect of the MIDI Byte 3 [184] (sometimes also known as MIDI data byte two) is thus as if adding another “multiplier” which only comes into play at the moment the message is received, and which has the result of scaling the “maximum” or amplitude [211] (t=1) to be somewhere 0-100%. That affects how the entire ADSR curve unfolds from there, differently for each message event.

ADSR Summary Description

Attack

Referring to FIG. 35, the time it takes to reach the initial target amplitude value [211] at time (t=1), from a beginning amplitude value [210] at time (t=0).

Decay

Referring to FIG. 35, the time it takes to fall from the initial target value [211] at (t=1) to the sustain value [217] at (t=2); (this may or may not be apparent depending on the combination of settings.)

Sustain

Referring to FIG. 35, this is a second target amplitude value [217] at time (t=2) that can (depending on the combination of settings) acts a value plateau, which is maintained until the Release at time (t=3) begins.

Release

The time it takes to fall from the Sustain plateau amplitude level [217] at time (t=3) to the ending amplitude value [214] at time (t=4), and which equals starting amplitude value [210].

V-ADSR is Applicable to All Transfer Functions

The Visual ADSR function can be applied through an Animator to the transformation of most any parameter of any model, actor, texture and effect. Thus ADSR may be applied to virtually all transfer functions in the visualizer. It is universally and equally applicable regardless of whether the animator is operating in very different feature spaces, such as some video effects applied to a video texture as contrasted to some 3D geometric model morphing.

V-ADSR Enhances Human Pattern Recognition in Feedback Loops Any spatio-temporal symmetry including the V-ADSR envelopes (and application of internal oscillators) to animations in the Visualizer greatly aid human pattern recognition—including both passive, and active (using keys on a MIDI piano for example). This is because the human brain is as much or even more attuned to recognizing derivatives or second-orders of change (i.e. rates of change, direction of change, rate of change of rate of change, etc.) as compated to the fixed resulting changed (or maximum value) states. Due to this aspect of human perception, in a brief glance through even a few percentage points of time/space over the total value scope of a particular V-ADSR's envelope, one can perceive “where an animation is going” and “where an animation came from”; and this holds true for most any animatable parameter.

The result is that more simultaneous changes can be superposed in the perceptual field without confusion, aiding in distinct recognition of each superposed feedback loop. It is well known that the processing of the human visual cortex is far more capable in this regard than the audio cortex. One can easily absorb and simultaneously understand a complex visual field with 5 animated objects, as contrasted to for example, trying to understand five simultaneous verbal conversations. Mathematically this is because the visual field involves a higher number of dimensions, many more degrees of freedom than audio, as a signal. When the two signal types are highly correlated, however in our synesthetic cybernetic media system, the affect is even more pronounced, and the audio and visual aspects reinforce each other making pattern recognition even further improved. V-ADSR amplifies and enhances all of these desirable effects.

8. Symmetric Transfer Functions and Perceived Beauty

Asymmetry, Symmetry, Visual Harmony and Beauty

Our everyday experience of the common mirrored kaleidoscope toy, illustrates the power of symmetry applied even to chaos in engendering what is experienced as beauty. Even the most common (and inherently asymmetrical) objects when placed inside—such as rocks, random bits of glass, a piece of string, and so forth—are transformed into a pleasing experience. By employing n)-axis of reflective symmetry, predominant spatial frequencies are created by the relationships between reflections, and thus generating an subjective sensation of visual harmony. When the tube is rotated and the random items are tumbled, the effect is even more dramatic, as by doing so there is animation while retaining the field of symmetric spatial frequency harmonics throughout, resulting in dynamic beauty and visual harmony.

The 3D Cybernetic Visualizer deeply exploits this spatial harmonic perceptual effect, however to a vastly more powerful scope and huge level of sophistication. For one thing, the various animatable parameters of most all of the Models, have many types of symmetry embedded into their design. The effect of animating these parameters is thus analogous to the turning tube of the simple kaleidoscope. Just as no matter in which direction, or how fast, the tube is turned—the symmetries remain clearly pronounced—similarly the animation of these parameters by design does not break symmetry. However in the case of the 3D Visualizer, it is mathematically more like an (n)-dimensional tube with simultaneous (n)-mirrors and with a huge variety of objects being so affected.

The action of the Internal Oscillators [17] is applicable to any animatable parameter [63], and results in a continuous spatio-temporal symmetry, much like rotating the kaleidoscope tube. Closely akin to the use of the Oscillators is the V-ADSR logic, which brings a continuous cyclic behavior to most all animatable parameters.

However, as contrasted to the physical kaleidoscope, in the realm of pure virtual 3D geometries and textures, the 3D Visualizer in its actions is materially unconstrained. Design elements such as multiple superposition, multiple interpenetration, or variable transparency are all available and are even easy; by contrast they are not typically available, or are simply completely impossible using any physical objects made of matter.

The implication for interactivity is profound. Whatever actions one or 3D Visualizer players take (such as on their MIDI controller devices), it is as though they are inescapably constrained within an omni-symmetry, omni-harmonic manifold of transfer functions. It does not matter what actions they take; the media results are always perceived by themselves and others as beautiful.

Geometric Symmetry

Most of the parameters of utilized 3D Visualizer family of Models [47] such as the Sphere, Sphere2, Torus, Torus2, etc. exploit symmetry, including Nphi, Ntheta, V0, and U0. There is virtually always one or more axis of symmetry that can be located through any of these transformations.

Texture Symmetry

Most of the parameters of utilized 3D Visualizer family of Texture Objects [58] such as Bitmap, Bitmap2, Video, Video2, etc. employ symmetry. When a texture is “slid” or moved over the surface of a model, most often this is done for each segment of it's Nphi value thus maintaining various reflective symmetries throughout the shift. Similar texture-related symmetries may be found throughout their parameters.

Temporal Symmetry

All of the Animators utilizing the Internal Oscillators [17] and/or V-ADSR (see FIG. 35) exhibit spatio-temporal symmetry. In addition, when the 3D Visualizer is used together with an external sequencer, transport master, clock master, or Show Control system as commonly available, it may be synchronized in many ways. With the planned inclusion of 3D-Visualizer-internal time bases including SMPTE, MTC, MIDI clock and MIDI transport master capabilities, these effects can be achieved in standalone fashion and in even more ways.

9. Synesthesia

Overview of Synesthesia: the Concept and its ‘Rewards’

Usually when one experiences more than one sensation at the same moment in time (like light and sound), if feels like a single event or one perception—one is not quite sure where the sound ends and the light begins, they are somehow merged or blended, and to force-separate them can subjectively feel artificial or even somehow degraded. When taken to its most profound degree, that multi-sensory fusion phenomenon is termed “synesthesia” (or “synaesthesia” in the UK English spelling.) Passive examples would include a stage show where the lights pulse and change exactly to the beat of the music, and yes, watching a 3D Visualizer scene roll along to the music. Those are examples of passive 2-way, or “sound and light synesthesia.”

But when one does something, like dance, or play a drum or a piano, that's also a combination of body action (kinesthetic) and the sense of touch together with sound (mainly), which is a kind of “3-way active synesthesia”. Dancing in a nightclub you feel the rhythmic position of your body and the pressure of your feet on the floor, matching the beat of the sound, and in time with the disco lights as well. Much of the joy of such venues comes when everything is in sync together. Now what's really compelling and even profound is when 3-way (sound/light/kinesthetic) or 4-way (sound/light/kinesthetic/tactile) synesthesia is experienced in terms of unified acts of creation. Now, one can feel body motion, and feel touch on fingers, and hear the sound made, and see a visual result also created. Then there is a powerful form of synesthesia created. What's interesting is that in that case, one senses a unification of cause and effect, or merging creating and creation. Subjectively this is experienced as if a magical realm to explore. One is transported to where, as a creator one is as if “at one through my body with my sound and light creations.” And when the sound is harmonious and pleasing, and the sight is beautiful “eye candy,” and when such creative acts are constructed by the transfer functions of the employed system to be effortless, then one has entered a compelling, delightful and fascinating realm of creative music and art.

What is claimed is:

1. A visualization method for real-time modulation of visual object parameters of an 3D computer graphics animation, the method comprising:
a. A real-time software runtime interpreter having one or more visualizer 3D ‘scenes’ comprised of a matrix of input-output control transfer functions loaded into RAM prior to runtime from an external non-volatile data store;
b. Loading of a plurality of 3D resources from an external data store prior to runtime into RAM data utilized by the interpreter and applying and modulating such resources during runtime in the output 3D visual space;
c. Production and output of 3D animation modulations and effects that are precisely synchronized with simultaneously presented musical content;
d. Allowing of simultaneous real-time control inputs from a plurality of control sources;
e. Allowing of simultaneous modulation of a plurality of 3D objects and their parameters including 3D spatial geometry of models, 3D applied surface textures, 3D particles and video effects;
f. Production in real-time of visualizer outputs on a primary display device or window of either a 2D (CRT or other panel) or 3D (stereoscopic or volumetric) type;
g. Input of streaming digital video resource in real-time into the interpreter and applying and modulating such resources at runtime in the output 3D visual space;

2. The system of claim 1, wherein simultaneous to the 3D scene output display, an secondary display or window is provided for the software interpreter's representation of a visualizer scene that is graphically presented to the user in terms of a hierarchical “nodes graph”, comprising:
a. A default new scene provides initial required objects;
b. Additional scene objects may be inserted by simple menu selections and keyboard quick-key commands;
c. Node graph objects may be reordered by drag-and-drop editing;
d. Once input control sources and output objects are inserted into the scene nodes graph, an auto-routing feature of the interpreter's GUI assists in completing the transfer function definition by auto-inserting an appropriate “route.” This is especially productive and useful when applied to particle engine effects;
e. Hierarchical nodes in the nodes graph can be expanded or collapsed for editing convenience (where children beneath a given node may be hidden or revealed);
f. Additional detailed parameter settings for objects in the nodes graph window are accessed by double-clicking on the object name or icon in the nodes graph to reveal their detail windows;
g. For objects in a given scene, any and all object parameters in their corresponding detail windows can optionally be manipulated in real-time by mouse increment/decrement drags, and/or numeric ASCII keys, and the results in the 3D space are immediately and in real-time displayed in the primary scene display.

3. The system of claim 1, wherein the resources loaded into interpreter RAM includes a plurality of 3D Actors, 3D Models, 2D images and/or 2D movies (including AVI file type) and whereas all such resources are available for modulation(s) in the 3D visual output space and in real-time.

4. The system of claim 1, wherein the plurality of real-time control inputs includes any combination of previously user-created control recordings; internal oscillators; computer keyboard and mouse actions; the audio spectrum; and/or MIDI protocol messages from any MIDI device, software or instrument, and furthermore comprising:
a. Means whereby any simultaneous weighted combination of control inputs to comprise a ‘control blend’ used to modulate 3D visual objects and their parameters;
b. Means whereby a plurality of such control blends to simultaneously modulate 3D visual objects and their parameters;
c. Means whereby a sufficiently broad scope and richness in output modulation parameters and scene setup topologies such that a given scene's matrix of transfer functions may be designed with considerably distinct (perceptually orthogonal) feature spaces thereby enhancing simultaneous multi-player distinction of feedback, as well as enhancing perception of simultaneous feature modulations on a given object (such as shape and texture and color modulation on a single object, such modulations derived from simultaneous control sources.)
d. Means by which imultaneous players including one (local) ASCII keyboard and mouse player (if any) together with an unlimited number of MIDI device players.
e. Means by which layers can be local or remote via MIDI over TCP/IP.

5. The system of claim 1, wherein a plurality of simultaneous control blends may be allocated by considered scene design and of their transfer functions to reside in adjacent control ranges both within each control type, and in correlation between different control types, such a system comprising means whereby:
a. Various audio spectrum frequency “bins” whether adjacent in frequency or not, may each be allocated to different transfer functions of any provided modulation means and may be applied to any output 3D scene object(s) or parameter(s);
b. Various computer keyboard keys, may each be allocated to different transfer functions of any provided visual modulation means and may be applied to any output 3D scene object(s) or parameter(s);
c. Various MIDI instrument keys and controls, may each be allocated to different transfer functions of any provided visual modulation means and may be applied to any output 3D scene object(s) or parameter(s);
d. A plurality of such adjacent control ranges may be correlated between different control types, such that for example a first control input range for each of keyboard, audio spectrum and MIDI device have the identical or similar modulation effect in one aspect (object(s) and/or parameter(s)) of the 3D output visual space; a second control input range for each of keyboard, audio spectrum and MIDI device have identical or similar modulation effect in a second and distinct aspect (object(s) and/or parameter(s)) of the 3D output visual space, and so forth similarly for any number of such adjacent control ranges and for any number of output modulation effect(s).

6. The system of claim 5, wherein the control input-output topology of transfer functions (routing) exhibits substantially flexible programmability in scene design, such a system comprising means whereby:
a. Routing may exhibit a one-to-many topology of one control blend to (n) parameters modulation;
b. Routing may exhibit a many-to-one topology of (n) control blends to one output parameter modulation;
c. Routing may exhibit a many-to-many topology of (n) control blends to (n) output parameters modulation;
d. Routing may exhibit a one-to-one topology of one control blend to one output parameter modulation;
e. In a given scene a plurality of such transfer function routings may co-reside in any combination of such routing topologies, for any number of routes, for any number of control blends, and for any number of output parameters (numeric limits being imposed only by the capacity of RAM memory of the interpreter).

7. The system of claim 1, wherein the software algorithmic and data structures approach to implementation of the 3D visualizer interpreter results is highly efficient rendering resulting in high frame rates for a true real-time 3D visualization.

8. The system of claim 1, wherein the number of available types of real-time modulation objects includes at least fourteen different object families including for: background, camera, 3D transform, object, switch, touch-sensor, 3D model, 2D texture (applicable to 3D surfaces), 3D animator, 3D light, route, interpolator, slider, and keyboard sensor; and furthermore comprising means whereby:
a. Families of object types each may include from 1 to 19 or more individual objects (for example in the 3D Model case such as plane, sphere, torus, shell, box, cone, hedron, isohedron, etc.);
b. All individual object types for all object families when taken together comprise on the order of 74 or more unique and fully real-time modulation objects;
c. Individual objects include on the order of from 2 to 45 different modulation parameters and typically average a dozen or more each (for example in the case of camera 14 parameters including X, Y and Z position; X, Y and Z orientation; angle; field of view; speed; spin speed; tilt; height; drop opacity; and navigation);
d. All individual parameters for all individual object types for all object families when taken together comprise on the order of 784 unique, real-time modulation parameters; each and any of these may be utilized by the interpreter in a single and/or a plurality of instances of that parameter in any given scene;

9. The system of claim 8, wherein the interpreter's secondary GUI windows, specifically within any object detail (parameters) window, provides an automated means for the user to quickly auto-increment through a large number of parameter combinations for a given object, in order to set defaults for the object in that particular scene, as well as to easily find and set aesthetic limits for that object's parameter modulations. This Auto-Scene-Creator feature allows automatic scene creation by exploiting the maximum threshold of visualizer variables to create nearly an infinite set of visualizer scenes.

10. The system of claim 1, wherein any and all routed transfer function(s) between any control input source(s) and any output modulated parameter(s), may exhibit a response curve with four distinct time segments (vs. amplitude) namely arrack, decay, sustain and release, such a system comprising means whereby;
a. When applied, such Visual-ADSR or V-ADSR provides an aesthetic character to any and all of the interpreter's visual modulations, being similar in result (but in visual terms) to the well-known aesthetic character of such response curves when applied in the audio domain of a musical note or event;
b. Visual-ADSR brings a smooth, continuous character to animation effects when applied in the visual domain, even in the presence of such as binary MIDI or ASCII keyboard triggers as the control source, i.e. input triggers having no variable velocity;
c. V-ADSR represents an application of symmetry to an input trigger;
d. When velocity is present in the input control source, that is taken into account in the V-ADSR response;
e. V-ADSR may optionally be applied to transfer functions (animators) for ASCII Keyboard, MIDI, and/or Audio. It operates identically as to the nature of the response curves applied, even when used for effects in totally different feature spaces (i.e. texture shifting as contrasted with geometric shape morphing.)
f. V-ADSR settings may be individually applied and independently adjusted for each and every transfer function (animator) it is applied to; (i.e. it is not a global setting.)

11. The system of claim 5, wherein the setup of MIDI transfer functions (MIDI animators) may be setup, the various different supported MIDI message types may be setup to exhibit certain general types of spatio-temporal response “styles” of behavior; and comprising means to implement such “styles” including:
a. Disable: no animation effect active (available with all supported message types);
b. Smooth: smoothly ramps from the minimum value to the maximum value, then smoothly ramps back to minimum value; (available with Note On/Off, Polyphonic Aftertouch, Control Change, and Pitch Bend);
c. Jump: suddenly jumps from the minimum to the maximum value, then suddenly jumps back to minimum value; (available only with Note On/Off;);
d. Smooth Up Jump Back: smoothly ramps from the minimum value to the maximum, then jumps back to the minimum value; (available with Note On/Off, Control Change and Pitch Bend).
e. Multi-Jump: Smoothly ramps from minimum to maximum value, jumps back to the minimum value, and repeats the cycle; (available only with Polyphonic Aftertouch).

12. The system of claim 1, wherein also a Real-time-Network-Updater functionality allows multiple users to simultaneously co-create and run visualizer scenes in real-time and effect the changes in a networked community environment, where in visualizer variables are interactively updated in real-time thus enabling scene co-creation and co-play in a global environment.
